(19) United States
(12) Patent Application Publication
(10) Pub. No.: US 2024/0430776 A1
(43) Pub. Date: Dec. 26, 2024

(54) COMMUNICATION METHOD AND APPARATUS

(71) Applicant: Huawei Technologies Co., Ltd., Shenzhen (CN)

(72) Inventors: Qi Feng, Shanghai (CN); Zhang Zhang, Shanghai (CN); Zhongfeng Li, Shanghai (CN)

(21) Appl. No.: 18/825,583

(22) Filed: Sep. 5, 2024

Related U.S. Application Data
(63) Continuation of application No. PCT/CN2023/075806, filed on Feb. 14, 2023.

(30) Foreign Application Priority Data
Mar. 7, 2022 (CN) 202210221809.1

(51) Int. Cl. H04W 40/22; H04W 40/08; H04W 40/12

(52) U.S. Cl. CPC H04W 40/22; H04W 40/08; H04W 40/12

(57) ABSTRACT

A method includes: a first node determines a main path, where the main path includes a transmission path that is between the first node and a second node and that meets a condition; determines a third node and a transmission configuration parameter based on the main path, where the third node is a node through which the transmission path between the first node and the second node necessarily passes; and sends, to the third node, the transmission configuration parameter used to determine a transmission manner between neighboring third nodes.

### CROSS-REFERENCE TO RELATED APPLICATIONS

This application is a continuation of International Application No. PCT/CN2023/075806, filed on Feb. 14, 2023, which claims priority to Chinese Patent Application No. 202210221809.1, filed on Mar. 7, 2022. The disclosures of the aforementioned applications are hereby incorporated by reference in their entireties.

### TECHNICAL FIELD

This disclosure relates to the communication field, and more specifically, to a communication method and apparatus.

### BACKGROUND

With the development of communication technologies, high frequency and large bandwidth become development trends of wireless communication in the future. An increase in a communication frequency band causes a reduction in a coverage area. Therefore, sidelink coordinated communication may be added based on conventional uplink and downlink communication. However, due to limitations of power and a signal processing capability of a device, long-distance transmission cannot be performed. In this case, a relay multi-hop transmission manner may be introduced for coordinated communication.

For example, based on conventional uplink and downlink point-to-point transmission, deploying an integrated access and backhaul (JAB) node may enhance uplink coverage, and the IAB node may serve as a relay node to forward, to a base station (BS), an uplink signal sent by a terminal device. In this communication mode, the BS may centrally allocate a receiving time unit and a transmitting time unit, an available resource (for example, an available time resource, frequency resource, or space resource), and a transmission path for the IAB node and the terminal device, to avoid a conflict between transport blocks at the IAB node, thereby ensuring transmission reliability and satisfying a delay requirement.

However, the foregoing communication mode in which a centralized control node (for example, a BS) centrally performs configuration lacks flexibility and scalability, and cannot be applicable to a communication network without a centralized control node.

### SUMMARY

This disclosure provides a communication method and apparatus, to improve communication flexibility.

According to a first aspect, a communication method is provided. The method may be performed by a first node. The first node may be a terminal device or a network device, or may be a component (such as a chip or a chip system) configured in a terminal device or a network device. This is not limited in this disclosure. The method includes: The first node determines a main path, where the main path includes a transmission path that is between the first node and a second node and that meets a condition; determines a third node and a transmission configuration parameter based on the main path, where the third node is a node through which the transmission path between the first node and the second node necessarily passes; and sends the transmission configuration parameter to the third node, where the transmission configuration parameter is used to determine a transmission manner between neighboring third nodes.

Based on the foregoing solution, the first node may be a source node, and the second node may be a destination node. The source node may determine the third nodes on the main path to centrally configure the transmission configuration parameter for the third nodes, and transmit the transmission configuration parameter to the third nodes, so that the third nodes can determine the transmission manner between the neighboring third nodes. The transmission manner includes a transmission path, and the transmission path includes a direct transmission path (for example, a single-hop path, that is, only one hop is required between the neighboring third nodes) between the neighboring third nodes, and a relay transmission path (for example, a multi-hop path, that is, a plurality of hops are required between the neighboring third nodes, a relay-assisted node between the neighboring third nodes may vary, and a quantity of relay-assisted nodes may also vary) between the neighboring third nodes. It can be learned that, the transmission manner between the neighboring third nodes is flexible, may be selected based on a requirement, and does not need to be centrally configured by the first node. For example, transmission reliability may be improved by increasing a quantity of relay nodes between the neighboring third nodes.

With reference to the first aspect, in some implementations of the first aspect, the condition includes any one of the following: a hop count from the first node to the second node is minimum, or a path loss from the first node to the second node is minimum.

Based on the foregoing solution, when determining the main path, the first node may determine the main path based on a feature of a wireless environment. For example, in an Internet of Vehicles scenario in which a network node quickly enters and exits, a channel between network nodes changes rapidly, that is, it is difficult to obtain channel quality in real time. Therefore, the source node may determine the main path according to a minimum hop count criterion. Alternatively, in an industrial Internet scenario, a network node is fixed, and a channel changes slowly. Therefore, the source node may determine the main path according to a minimum path loss criterion.

With reference to the first aspect, in some implementations of the first aspect, the first node determines the third node and the transmission configuration parameter based on the main path and at least one of the following: a quantity of transport blocks, a threshold of a bit error rate, a total transmission delay, a duplex capability of a node on the main path, and a quantity of nodes.

In the foregoing solution, the bit error rate may also be understood as a bit error rate or a block error (e.g. a code block) rate. This is not limited in this disclosure. In a process of determining the third node and the transmission configuration parameter, for example, when a quantity of transport blocks is large, a node receiving/transmitting periodicity may be appropriately shortened, that is, time for waiting for sending the transport block may be reduced. When a quantity of transport blocks is smaller, a quantity of third nodes may be appropriately decreased. For another example, for high-reliability transmission (for example, a bit error rate is low and is less than a threshold), a quantity of third nodes may be decreased, and a quantity of relay nodes between neighboring third nodes may be appropriately increased, because transmission reliability may be improved by providing more paths between the neighboring third nodes. For another example, if a quantity of nodes in a communication system is small, a quantity of third nodes may be appropriately increased, to decrease a quantity of relay nodes between neighboring third nodes, thereby reducing complexity of coordinated transmission.

With reference to the first aspect, in some implementations of the first aspect, the transmission configuration parameter includes at least one of a node receiving/transmitting periodicity and a transmission delay between the neighboring third nodes.

Based on the foregoing solution, the first node configures the node receiving/transmitting periodicity and/or the transmission delay between the neighboring third nodes for the third node, to prevent a congestion, a conflict, and a collision from occurring in a process in which a transport block reaches a destination node from a source node through a plurality of hops.

With reference to the first aspect, in some implementations of the first aspect, the third node is a half-duplex node, and the transmission configuration parameter further includes a transmitting time unit and a receiving time unit.

Based on the foregoing solution, when the third node is a half-duplex node, the third node cannot simultaneously receive and send a transport block. Therefore, a transmitting time unit and a receiving time unit need to be further configured for the third node, to avoid a conflict between the transmitting time unit and the receiving time unit.

With reference to the first aspect, in some implementations of the first aspect, the first node obtains configuration information of a neighboring node, where the configuration information includes a next-hop node, a destination node, and a hop count, or the configuration information includes a next-hop node, a destination node, and a path loss; and determines the main path based on the configuration information.

Based on the foregoing solution, a node in a network may exchange configuration information with a neighboring node, to determine a preferred main path between a source node and a destination node.

According to a second aspect, a communication method is provided. The method may be performed by a third node. The third node may be a terminal device or a network device, or may be a component (such as a chip or a chip system) configured in a terminal device or a network device. This is not limited in this disclosure. The method includes: The third node obtains a transmission configuration parameter, where the transmission configuration parameter is used to determine a transmission manner between neighboring third nodes, a main path includes a transmission path that is between a first node and a second node and that meets a condition, and the third node is a node through which the transmission path between the first node and the second node necessarily passes; and determines the transmission manner between the neighboring third nodes based on the transmission configuration parameter.

Based on the foregoing solution, the first node may be a source node, and the second node may be a destination node. The third node obtains the transmission configuration parameter configured by the first node, so that the third node can determine the transmission manner between the neighboring third nodes. The transmission manner includes a transmission path, and the transmission path includes a direct transmission path (for example, a single-hop path, that is, only one hop is required between the neighboring third nodes) between the neighboring third nodes, and a relay transmission path (for example, a multi-hop path, that is, a plurality of hops are required between the neighboring third nodes, a relay node between the neighboring third nodes may vary, and a quantity of relay nodes may also vary, where the relay node is a node between the neighboring third nodes that participates in transmission) between the neighboring third nodes. It can be learned that, the transmission manner between the neighboring third nodes is flexible, may be selected based on a requirement, and does not need to be centrally configured by the first node. For example, transmission reliability may be improved by increasing a quantity of relay nodes between the neighboring third nodes.

With reference to the second aspect, in some implementations of the second aspect, the condition includes at least one of the following: a hop count from the first node to the second node is minimum, or a path loss from the first node to the second node is minimum.

Based on the foregoing solution, when determining the main path, the first node may determine the main path based on a feature of a wireless environment. For example, in an Internet of Vehicles scenario in which a network node quickly enters and exits, a channel between network nodes changes rapidly, that is, it is difficult to obtain channel quality in real time. Therefore, the source node may determine the main path according to a minimum hop count criterion. Alternatively, in an industrial Internet scenario, a network node is fixed, and a channel changes slowly. Therefore, the source node may determine the main path according to a minimum path loss criterion.

With reference to the second aspect, in some implementations of the second aspect, the transmission configuration parameter includes at least one of a node receiving/transmitting periodicity and a transmission delay between the neighboring third nodes.

Based on the foregoing solution, the first node configures the node receiving/transmitting periodicity and/or the transmission delay between the neighboring third nodes for the third node, to prevent a congestion, a conflict, and a collision from occurring in a process in which a transport block reaches a destination node from a source node through a plurality of hops.

With reference to the second aspect, in some implementations of the second aspect, the third node is a half-duplex node, and the transmission configuration parameter further includes a transmitting time unit and a receiving time unit.

Based on the foregoing solution, when the third node is a half-duplex node, the third node cannot simultaneously receive and send a transport block. Therefore, a transmitting time unit and a receiving time unit need to be further configured for the third node, to avoid a conflict between the transmitting time unit and the receiving time unit.

With reference to the second aspect, in some implementations of the second aspect, the third node determines information about the transmission manner between the neighboring third nodes based on the transmission configuration parameter, where the information about the transmission manner includes at least one of the following: a relay node between the neighboring third nodes, a quantity of relay nodes, and the transmission manner between the neighboring third nodes, and the relay node is a node between the neighboring third nodes that participates in transmission.

With reference to the second aspect, in some implementations of the second aspect, the transmission manner between the neighboring third nodes includes a transmission path and a time unit corresponding to the transmission path.

According to a third aspect, a communication apparatus is provided. The apparatus may be a first node. The first node may be a terminal device or a network device, or may be a component (such as a chip or a chip system) configured in a terminal device or a network device. This is not limited in this disclosure. The apparatus includes a transceiver unit and a processing unit. The processing unit is configured to determine a main path, where the main path includes a transmission path that is between the first node and a second node and that meets a condition. The processing unit is further configured to determine a third node and a transmission configuration parameter based on the main path, where the third node is a node through which the transmission path between the first node and the second node necessarily passes. The transceiver unit is configured to send the transmission configuration parameter to the third node, where the transmission configuration parameter is used to determine a transmission manner between neighboring third nodes.

With reference to the third aspect, in some implementations of the third aspect, the condition includes any one of the following: a hop count from the first node to the second node is minimum, or a path loss from the first node to the second node is minimum.

With reference to the third aspect, in some implementations of the third aspect, the processing unit determines the third node and the transmission configuration parameter based on the main path and at least one of the following: a quantity of transport blocks, a threshold of a bit error rate, a total transmission delay, a duplex capability of a node on the main path, and a quantity of nodes.

Alternatively, the bit error rate may be a bit error rate or a block error (e.g. a code block) rate. This is not limited in this disclosure.

With reference to the third aspect, in some implementations of the third aspect, the transmission configuration parameter includes at least one of a node receiving/transmitting periodicity and a transmission delay between the neighboring third nodes.

With reference to the third aspect, in some implementations of the third aspect, the third node is a half-duplex node, and the transmission configuration parameter further includes a transmitting time unit and a receiving time unit.

With reference to the third aspect, in some implementations of the third aspect, the transceiver unit is further configured to obtain configuration information of a neighboring node, where the configuration information includes a next-hop node, a destination node, and a hop count, or the configuration information includes a next-hop node, a destination node, and a path loss; and the processing unit is further configured to determine the main path based on the configuration information.

According to a fourth aspect, a communication apparatus is provided. The apparatus may be a third node. The third node may be a terminal device or a network device, or may be a component (such as a chip or a chip system) configured in a terminal device or a network device. This is not limited in this disclosure. The apparatus includes a transceiver unit and a processing unit. The transceiver unit is configured to obtain a transmission configuration parameter, where the transmission configuration parameter is used to determine a transmission manner between neighboring third nodes, a main path includes a transmission path that is between a first node and a second node and that meets a condition, and the third node is a node through which the transmission path between the first node and the second node necessarily passes. The processing unit is configured to determine the transmission manner between the neighboring third nodes based on the transmission configuration parameter.

With reference to the fourth aspect, in some implementations of the fourth aspect, the condition includes at least one of the following: a hop count from the first node to the second node is minimum, or a path loss from the first node to the second node is minimum.

With reference to the fourth aspect, in some implementations of the fourth aspect, the transmission configuration parameter includes at least one of a node receiving/transmitting periodicity and a transmission delay between the neighboring third nodes.

With reference to the fourth aspect, in some implementations of the fourth aspect, the third node is a half-duplex node, and the transmission configuration parameter further includes a transmitting time unit and a receiving time unit.

With reference to the fourth aspect, in some implementations of the fourth aspect, the processing unit is further configured to determine information about the transmission manner between the neighboring third nodes based on the transmission configuration parameter, where the information about the transmission manner includes at least one of the following: a relay node between the neighboring third nodes, a quantity of relay nodes, and the transmission manner between the neighboring third nodes, and the relay node is a node between the neighboring third nodes that participates in transmission.

With reference to the fourth aspect, in some implementations of the fourth aspect, the transmission manner between the neighboring third nodes includes a transmission path and a time unit corresponding to the transmission path.

According to a fifth aspect, a communication apparatus is provided. The apparatus includes a processor. The processor is coupled to a memory, and may be configured to execute instructions in the memory, to implement the method according to either of the first aspect and the second aspect and any one of the possible implementations of the first aspect and the second aspect. Optionally, the apparatus further includes a memory. The memory and the processor may be separately deployed, or may be deployed together. Optionally, the apparatus further includes a communication interface, and the processor is coupled to the communication interface.

In an implementation, the communication interface may be a transceiver or an input/output interface.

In another implementation, the apparatus is a first node (or a third node) or a chip configured in a first node (or a third node), and the first node and the third node may be a terminal device or a network device. When the apparatus is the chip configured in the first node (or the third node), the communication interface may be an input/output interface, an interface circuit, an output circuit, an input circuit, a pin, a related circuit, or the like on the chip or a chip system. The processor may alternatively be implemented as a processing circuit or a logic circuit.

Optionally, the transceiver may be a transceiver circuit. Optionally, the input/output interface may be an input/output circuit.

In a specific implementation process, the processor may be one or more chips, the input circuit may be an input pin, the output circuit may be an output pin, and the processing circuit may be a transistor, a gate circuit, a trigger, any logic circuit, or the like. An input signal received by the input circuit may be received and input by, but not limited to, a receiver, a signal output by the output circuit may be output to, but not limited to, a transmitter and transmitted by the transmitter, and the input circuit and the output circuit may be a same circuit, where the circuit separately serves as the input circuit and the output circuit at different moments. Specific implementations of the processor and the various circuits are not limited in embodiments of this disclosure.

According to a sixth aspect, a communication apparatus is provided. The apparatus includes a logic circuit and an input/output interface, and the logic circuit is configured to be coupled to the input/output interface, and transmit data through the input/output interface, to perform the method according to either of the first aspect and the second aspect and any one of the possible implementations of the first aspect and the second aspect.

According to a seventh aspect, a computer-readable storage medium is provided. The computer-readable storage medium stores a computer program (which may also be referred to as code or instructions). When the computer program is run on a computer, the computer is enabled to perform the method according to either of the first aspect and the second aspect and any one of the possible implementations of the first aspect and the second aspect.

According to an eighth aspect, a computer program product is provided. The computer program product includes a computer program (which may also be referred to as code or instructions). When the computer program is run, a computer is enabled to perform the method according to either of the first aspect and the second aspect and any one of the possible implementations of the first aspect and the second aspect.

For specific beneficial effects brought by the third aspect to the eighth aspect, refer to the descriptions of the beneficial effects in the first aspect and the second aspect. Details are not described herein again.

### BRIEF DESCRIPTION OF THE DRAWINGS

FIG. 1 is a diagram of a network architecture according to an embodiment of this disclosure;

FIG. 2 is a diagram of another network architecture according to an embodiment of this disclosure;

FIG. 3 is a flowchart of a communication method according to an embodiment of this disclosure;

FIG. 4 is a schematic of a multi-hop network topology according to an embodiment of this disclosure;

FIG. 5(a) to FIG. 5(c) are schematics of different quantities of third nodes in a same network topology according to an embodiment of this disclosure;

FIG. 6A to FIG. 6C are diagrams of transmission manners in which both a third node and a relay node are full-duplex nodes according to an embodiment of this disclosure;

FIG. 7A to FIG. 7C are diagrams of transmission manners in which a third node is full-duplex node and a relay node is half-duplex node according to an embodiment of this disclosure;

FIG. 8A to FIG. 8C are diagrams of transmission manners in which both a third node and a relay node are half-duplex nodes according to an embodiment of this disclosure;

FIG. 9 is a diagram of a communication apparatus according to an embodiment of this disclosure;

FIG. 10 is a diagram of a structure of another communication apparatus according to an embodiment of this disclosure;

FIG. 11 is a diagram of a structure of a terminal device according to an embodiment of this disclosure; and

FIG. 12 is a diagram of a structure of still another communication apparatus according to an embodiment of this disclosure.

### DETAILED DESCRIPTION OF ILLUSTRATIVE EMBODIMENTS

The following describes the technical solutions in this disclosure with reference to the accompanying drawings.

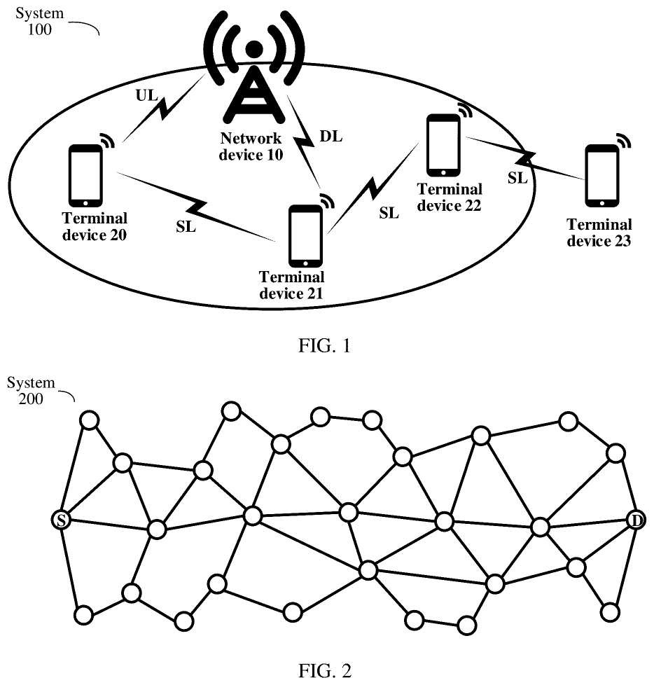

FIG. 1 is a diagram of a network architecture according to an embodiment of this disclosure.

A system 100 shown in FIG. 1 includes at least one network device and at least one terminal device, for example, a network device 10, a terminal device 20, a terminal device 21, a terminal device 22, and a terminal device 23. The network device 10 and the terminal device communicate with each other over an uplink and a downlink, and the terminal devices communicate with each other over a sidelink (SL). For example, the network device 10 sends signaling/data to the terminal device 21 over a downlink (DL), and the terminal device 20 sends signaling/data to the network device over an uplink (UL). The terminal device 20 communicates with the terminal device 21 over a sidelink, and the terminal device 21 communicates with the terminal device 22 over a sidelink. When the terminal device 23 is not in a coverage area of the network device 10, the terminal device 22 may serve as a relay node to assist in communication between the terminal device 23 and another device. In this case, the terminal device 22 may be an IAB node. Alternatively, communication between the terminal device 23 and another device may be assisted in an intelligent reflecting surface (IRS) relay manner.

FIG. 2 is a diagram of another network architecture according to an embodiment of this disclosure.

A system 200 shown in FIG. 2 may be a mesh network, and includes a plurality of nodes. Each hollow circle represents one node, the node may be a terminal device, and a connection line between two hollow circles may be understood as a sidelink. S (that is, source) represents a source node, and D (that is, destination) represents a destination node. It can be learned that, there are a plurality of transmission paths for selection between the source node and the destination node, and each transmission path requires a plurality of hops. Therefore, the transmission path may also be referred to as a multi-hop transmission path.

In the system 100, in a scenario in which a relay node assists in communication, a topology relationship of a relay forwarding manner in this scenario is relatively simple. A network device may centrally configure transmission parameters for the relay node and the terminal device, for example, a receiving time unit, a transmitting time unit, an available resource (for example, an available time resource, frequency resource, or space resource), and a transmission path (for example, direct communication between the network device and the terminal device, or relay-assisted communication between the network device and the terminal device). Therefore, a conflict that is between a receiving time unit and a transmitting time unit of a transport block and that is at the relay node can be avoided, thereby ensuring transmission reliability and satisfying a delay requirement.

However, the manner in which the network device centrally configures the transmission parameter for each relay node and each terminal device has relatively poor flexibility and scalability, cannot be adjusted in real time based on a service requirement and a channel quality change, and cannot be applied to a communication system without a centralized control node like the system 200.

In view of this, this disclosure provides a communication method, to improve communication flexibility and reliability, and is applicable to more communication systems.

The technical solutions in embodiments of this disclosure may be applied to various communication systems, for example, a long term evolution (LTE) system, a long term evolution advanced (LTE-A) system, an LTE frequency division duplex (FDD) system, an LTE time division duplex (TDD) system, a universal mobile telecommunications system (UMTS), a worldwide interoperability for microwave access (WiMAX) communication system, a 5th generation (5G) system, a future evolved communication system (for example, a 6G mobile communication system), vehicle-to-X (V2X), where V2X may include vehicle to network (V2N), vehicle to vehicle (V2V), vehicle to infrastructure (V2I), vehicle to pedestrian (V2P), and the like, long term evolution-vehicle (LTE-V), an Internet of vehicles, machine type communication (MTC), an internet of things (IoT), long term evolution-machine (LTE-M), machine to machine (M2M), and the like.

The terminal device in embodiments of this disclosure may be a wireless terminal device that can receive scheduling and indication information of the network device. The terminal device may be a device that provides a user with voice and/or data connectivity, a handheld device having a wireless connection function, or another processing device connected to a wireless modem.

The terminal device may also be referred to as a terminal, an access terminal, a subscriber unit, user equipment (UE), a subscriber station, a mobile station, a remote station, a remote terminal, a mobile device, a user terminal, a wireless communication device, a user agent, or a user apparatus. The terminal device is a device that includes a wireless communication function (providing a user with voice/data connectivity), for example, a handheld device or an in-vehicle device that has a wireless connection function. The terminal device in embodiments of this disclosure may be a mobile phone, a tablet computer (e.g. a pad), a computer with a wireless receiving/transmitting function, a train, an airplane, a mobile Internet device (MID), a virtual reality (VR) terminal, an augmented reality (AR) terminal, a wireless terminal (for example, a robot) in industrial control, a wireless terminal in an Internet of vehicles (for example, an in-vehicle device, a vehicle device, an in-vehicle module, or a vehicle), a wireless terminal in self driving, a wireless terminal in telemedicine or telehealth services, a wireless terminal in a smart grid, a wireless terminal in transportation safety, a wireless terminal in a smart city, a wireless terminal in a smart city, a wireless terminal in a smart home, a cellular phone, a cordless phone, a session initiation protocol (SIP) phone, a wireless local loop (WLL) station, a personal digital assistant (PDA), a handheld device having a wireless communication function, a computing device, another processing device connected to a wireless modem, an in-vehicle device, a wearable device, a terminal in a 5G network, a terminal in a future evolved network, or the like.

The wearable device may also be referred to as a wearable intelligent device, and is a general term of wearable devices, such as glasses, gloves, watches, clothes, and shoes, that are developed by applying wearable technologies to intelligent designs of daily wear. The wearable device is a portable device that can be directly worn on the body or integrated into clothes or accessories of a user. The wearable device is not only a hardware device, but also implements a powerful function through software support, data exchange, and cloud interaction. In a broad sense, the wearable intelligent device includes a full-featured and large-sized device that can implement complete or partial functions without depending on a smartphone, for example, a smart watch or smart glasses, and a device that dedicates to only one type of application and needs to be used in cooperation with another device such as a smartphone, for example, various smart bands or smart jewelry used to monitor physical signs.

The network device in embodiments of this disclosure may be a device in a wireless network. For example, the network device may be a device that is deployed in a radio access network and that provides a wireless communication function for the terminal device. For example, the network device may be a radio access network (RAN) node that connects the terminal device to the wireless network, and may also be referred to as an access network device.

The network device includes but is not limited to: an evolved NodeB (eNB), a radio network controller (RNC), a NodeB (NB), a base station controller (BSC), a base transceiver station (BTS), a home base station (home evolved NodeB, HeNB, or a home NodeB, HNB), a baseband unit (BBU), an access point (AP) in a wireless fidelity (Wi-Fi) system, a wireless relay node, a wireless backhaul node, a transmission point (TP), a transmission and reception point (TRP), or the like. Alternatively, the network device may be a gNB or a transmission point (TRP or TP) in a 5G system such as an NR system, may be one antenna panel or a group (including a plurality of antenna panels) of antenna panels of a gNB in a 5G system, or may be a network node, such as a baseband unit (BBU) or a distributed unit (DU), that constitutes a gNB or a transmission point.

In some deployments, a gNB may include a central unit (CU) and a DU. The gNB may further include an active antenna unit (AAU). The CU implements some functions of the gNB, and the DU implements some functions of the gNB. For example, the CU is responsible for processing a non-real-time protocol and service, and implements functions of a radio resource control (RRC) layer and a packet data convergence protocol (PDCP) layer. The DU is responsible for processing a physical layer protocol and a real-time service, and implements functions of a radio link control (RLC) layer, a media access control (MAC) layer, and a physical (PHY) layer. The AAU implements some physical layer processing functions, radio frequency processing, and a function related to an active antenna. Information at the RRC layer is generated by the CU, and is finally encapsulated at the PHY layer of the DU into information at the PHY layer, or is converted from information at the PHY layer. Therefore, in this architecture, higher layer signaling, for example, RRC layer signaling, may also be considered as being sent by the DU or sent by the DU+AAU. It may be understood that the network device may be a device including one or more of a CU node, a DU node, or an AAU node. In addition, the CU may be classified into a network device in an access network (RAN), or the CU may be classified into a network device in a core network (CN). This is not limited in this disclosure.

To facilitate understanding of embodiments, the following terms are explained:
1. A multi-hop transmission delay is a delay required for a single transport block to reach an end point from a start point through multi-hop transmission. For a multi-hop transmission delay in a wireless mesh network, a start point is a source node, and an end point is a destination node. For a multi-hop transmission delay between neighboring third nodes in the wireless mesh network, a start point is a current third node, an end point is a next-hop third node of the current third node, and the third node is a node through which a transport block in the wireless mesh network necessarily passes on a multi-hop transmission path from the source node to the destination node.
2. A node receiving/transmitting periodicity is a minimum time interval between sending of two consecutive transport blocks, that is, a minimum time interval at which a transmitting/receiving time unit and a transmission path of any node in a wireless mesh network are periodically repeated after a communication system enters a stable state after a period of time. In other words, the transmitting/receiving time unit and the transmission path are periodically repeated as a whole, and the node receiving/transmitting periodicity is a minimum time interval between periodical repetitions.
3. A congestion is a phenomenon caused by different receiving/transmitting periodicities of nodes in a communication system, and may be understood as a delay phenomenon occurred when a transport block is transmitted from a node with a short receiving/transmitting periodicity to a node with a long receiving/transmitting periodicity.
4. A conflict is a mismatch between a receiving time unit and a transmitting time unit that is caused by a half-duplex node needing to send a transport block to a next-hop node and receive a transport block from a previous-hop node at a specific moment.
5. A collision means that two consecutive transport blocks cannot be correctly received because they reach a same node through different paths.

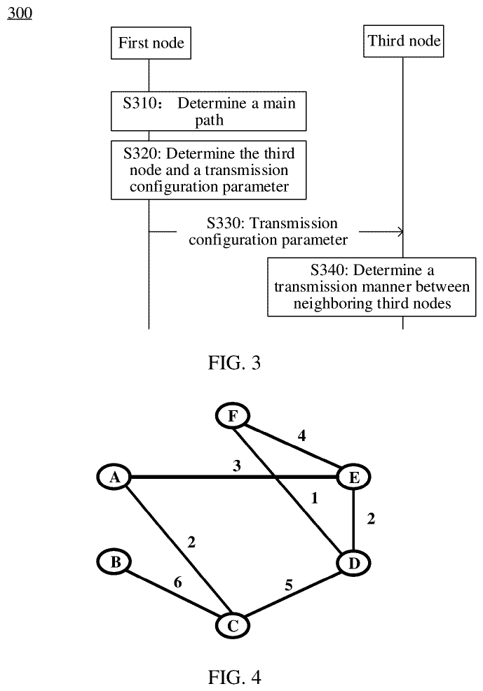

FIG. 3 is a flowchart of a communication method according to an embodiment of this disclosure. A method 300 shown in FIG. 3 includes the following steps.

S310: A first node determines a main path, where the main path includes a transmission path that is between the first node and a second node and that meets a condition.

It should be understood that, the first node is a source node, the second node is a destination node, the source node may be a terminal device or a network device, and the destination node may also be a terminal device or a network device.

For example, the condition includes a first condition or a second condition:
the first condition: a hop count from the first node to the second node is minimum; and
the second condition: a path loss from the first node to the second node is minimum.

In a possible implementation, the first node determines the main path based on the first condition.

For example, the first node is a source node, and the first node transmits a signal to the second node. Before transmitting the signal, the first node obtains configuration information of a node #1 (the node #1 is a node adjacent to the first node), where the configuration information includes a next-hop node, a destination node, and a hop count. Table 1 shows, by using routing table information as an example of the configuration information, a change of a routing table of the first node after the first node obtains a routing table of a node B. Before the change, a local routing table of the first node is a routing table #A1; and after the change, the local routing table of the first node is a routing table #A2. A routing table state change includes five types: add/replace/update/maintain/delete. A trigger condition of the state change includes the following:

(1) Add: If a destination node in the node B does not appear in the routing table #A1, the routing information is added.

For example, if a destination node T in a routing table #B of the node B does not appear in the routing table #A1, the routing information is added, that is, a route whose destination node is T appears in the routing table #A2.

(2) Replace: If a destination node in the routing table #B already appears in the routing table #A1, and a next-hop node that is in the routing table #A1 and that corresponds to the destination node is the node B, a next-hop node and a hop count of the route are replaced.

For example, if a destination node R in the routing table #B appears in the routing table #A1, and a next-hop node of a route in a fourth row of the routing table #A1 is the node B, a next-hop node D is replaced with the node B, and a hop count is replaced from 4 to 2.

(3) Update: If a destination node in the routing table #B already appears in the routing table #A1, a next-hop node that is in the routing table #A1 and that corresponds to the destination node is the node B, and a hop count corresponding to the routing table #B is less than a hop count corresponding to the routing table #A1, a hop count of the routing information in the routing table #A1 is updated.

For example, if a destination node O in the routing table #B already appears in the routing table #A1, a next-hop node that is in the routing table #A1 and that corresponds to the destination node is the node B, and a hop count 3 corresponding to the routing table #B is less than a hop count 6 corresponding to the routing table #A1, an updated hop count of the routing information in the routing table #A2 is 4.

(4) Maintain: If a destination node in the routing table #B already appears in the routing table #A1, a next-hop node that is in the routing table #A1 and that corresponds to the destination node is not the node B, and a hop count corresponding to the routing table #B is greater than a hop count corresponding to the routing table #A1, the routing information in the routing table #A1 is maintained.

For example, if a destination node Q in the routing table #B already appears in the routing table #A1, a next-hop node that is in the routing table #A1 and that corresponds to the destination node is a node C, and a hop count 5 corresponding to the routing table #B is greater than a hop count 3 corresponding to the routing table #A1, the routing information in the routing table #A1 is maintained.

(5) Delete: If routing table update information of the neighboring node B is not received in a period of time, routing information that is in the routing table #A1 and that indicates that a next-hop node is the node B is deleted.

It should be understood that, if the routing table update information of the neighboring node B is not received in a period of time, the node B may be offline. For example, the node B is powered off or is out of a coverage area. In this case, the routing information indicating that the next-hop node is the node B may be deleted.

TABLE 1

| Routing table #B | | | Routing table #A1 | | | Routing table # A2 | | | |
|---|---|---|---|---|---|---|---|---|---|
| of the node B | | | of the first node | | | of the first node | | | |
| | Next- | | | Next- | | | Next- | | |
| Destination | hop | Hop | Destination | hop | Hop | Destination | hop | Hop | |
| node | node | count | node | node | count | node | node | count | Status |
| O | H | 3 | O | B | 6 | O | B | 4 | Update |
| P | I | 4 | P | B | 2 | P | B | 5 | Update |
| Q | J | 5 | Q | C | 3 | Q | C | 3 | Maintain |
| R | K | 1 | R | D | 4 | R | B | 2 | Replace |
| T | L | 3 | S | E | 3 | S | E | 3 | Maintain |
| / | / | / | / | / | / | T | L | 4 | Add |

The first node exchanges a routing table with the node B, and updates the routing table to obtain a route with a minimum hop count to the destination node. Similarly, a route from the node B to the node C (adjacent to the node B) is determined by exchanging a routing table between the node B and the node C, and so on until a route between a node N (adjacent to the second node) and the second node is determined. After the first node sends the signal to the second node, the second node sends feedback information to the first node through an original path. The feedback information may indicate, to the first node, that the path reaches the second node, so that the first node can determine that the path is the main path.

It should be understood that the first condition is applicable to an Internet of Vehicles scenario. In the Internet of Vehicles scenario in which a network node quickly enters and exits, a channel between network nodes changes rapidly, that is, it is difficult to obtain channel quality in real time. Therefore, the source node may determine the main path based on the first condition. In another possible implementation, the first node determines the main path based on the second condition.

For example, the first node is a source node, and the first node transmits a signal to the second node. Before transmitting the signal, the first node obtains configuration information of a node #1 (the node #1 is a node adjacent to the first node), where the configuration information includes a next-hop node, a destination node, and a path loss.

The first node exchanges a routing table with the node #1, and updates the routing table to obtain a route with a minimum path loss to the destination node. Similarly, a route from the node #1 to a node #2 (adjacent to the node #1) is determined by exchanging a routing table between the node #1 and the node #2, and so on until a route between a node #n (the node #n is adjacent to the second node) and the second node is determined. After the first node sends the signal to the second node, the second node sends feedback information to the first node through an original path. The feedback information may indicate, to the first node, that the path reaches the second node, so that the first node can determine that the path is the main path.

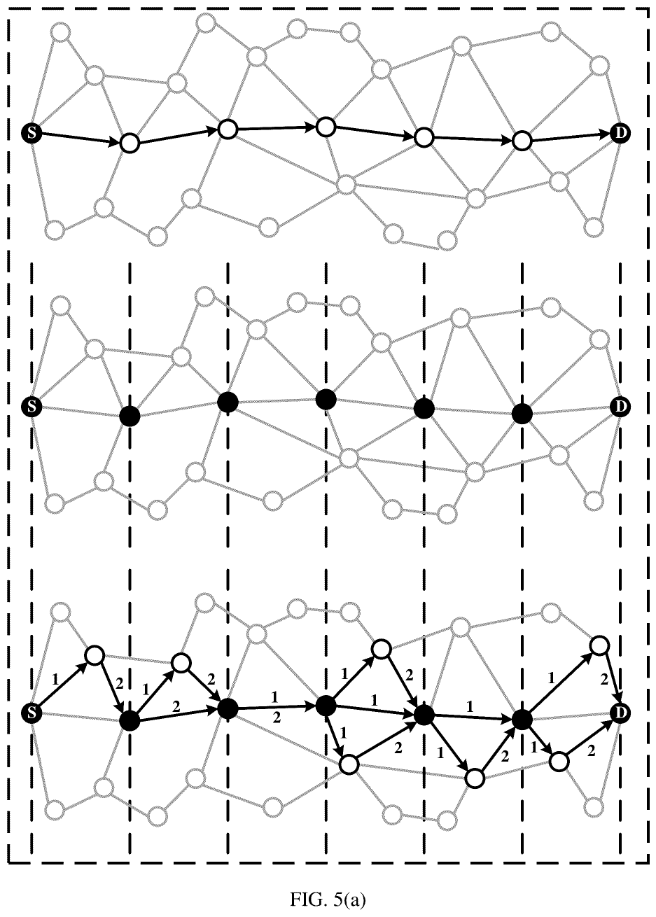

FIG. 4 is a schematic of a multi-hop network topology. A number in the figure represents a path loss. Table 2 shows an iterative update process of an optimal path. A specific process includes the following steps.

(1) A source node divides network nodes into a selected node set and a candidate node set. Initially, the selected node set includes only the source node, and the candidate node set includes a remaining network node other than the source node.

(2) The source node exchanges a routing table with a neighboring node; selects, from the candidate node set, a node with a small path loss to the source node; and moves the node from the candidate node set to the selected node set.

(3) An optimal path from the source node to each node in the selected node set is updated.

(4) Steps (2) and (3) are repeated until a destination node is included in the selected node set, and a main path with a minimum path loss from the source node to the destination node is obtained through iterative update.

TABLE 2

| | A | B | C | D | E | F |
|---|---|---|---|---|---|---|
| S1 | 0 | / | 2 | / | 3 | / |
| D1 | 0 | / | 2 | / | / | / |
| S2 | 0 | 8 | 2 | 7 | 3 | / |
| D2 | 0 | / | 2 | / | 3 | / |
| S3 | 0 | 8 | 2 | 5 | 3 | 7 |
| D3 | 0 | / | 2 | 5 | 3 | / |
| S4 | 0 | 8 | 2 | 5 | 3 | 6 |
| D4 | 0 | / | 2 | 5 | 3 | 6 |

For example, descriptions are provided with reference to FIG. 4 and Table 2. S (Selection) represents a path from the source node A to a node in the selected node set, and D (Determination) represents a path that has a small path loss and that is determined after routing table exchange between neighboring nodes. A is the source node, and F is the destination node.

Initially, the selected node set includes only the source node A. It can be learned from FIG. 4 that, the source node A is adjacent to the node C and the node E. After the source node A exchanges a routing table with the node C and the node E, it can be learned that a path loss between the source node A and the node C is 2, and a path loss between the source node A and the node E is 3. S1 represents performing selection from the candidate node set (the node C and the node E) communicating with the selected node set (the node A). D1 represents determining, from a path A-C and a path A-E, that a path with a small path loss is A-C, and adding the node C to the selected node set.

The node C is adjacent to the node B and the node D. The node C may learn, by exchanging a routing table with the node B and the node D, that a path loss between the node C and the node B is 6, and a path loss between the node C and the node D is 5. S2 represents performing selection from the candidate node set (the node B, the node D, and the node E) communicating with the selected node set (the node A and the node C). D2 represents determining, from a path A-C-B, a path A-C-D, and the path A-E, that a path with a small path loss is A-E, and adding the node E to the selected node set.

The node E is adjacent to the node D and the node F. The node E may learn, by exchanging a routing table with the node D and the node F, that a path loss between the node E and the node D is 2, and a path loss between the node E and the node F is 4. After the node E is introduced, a path A-E-D is newly added between the node A and the node D, and a path loss of A-E-D is less than a path loss of A-C-D. Therefore, a path with a minimum path loss between the node A and the node D is replaced with A-E-D. S3 represents performing selection from the candidate node set (the node B, the node D, and the node F) communicating with the selected node set (the node A, the node C, and the node E). D3 represents determining, from the path A-C-B, the path A-E-D, and a path A-E-F, that a path with a small path loss is A-E-D, and adding the node D to the selected node set.

The node D is adjacent to the node F. The node D may know, by exchanging a routing table with the node F, that a path loss between the node D and the node F is 1. After the node D is introduced, a path A-E-D-F is newly added between the node A and the node F, and a path loss of A-E-D-F is less than a path loss of A-E-F. Therefore, a path with a minimum path loss between the node A and the node F is replaced with A-E-D-F. S4 represents performing selection from the candidate node set (the node B and the node F) communicating with the selected node set (the node A, the node C, the node D, and the node E). D4 represents determining, from the path A-C-B and the path A-E-D-F, that a path with a small path loss is A-E-D-F, and adding the node F to the selected node set. In this case, the source node (the node A) may determine that the path A-E-D-F to the destination node (the node F) is the main path, and a path loss is 6.

It should be understood that the second condition is applicable to an industrial Internet scenario. In the industrial Internet scenario, a network node is fixed, and a channel changes slowly. Therefore, the source node may determine the main path according to a minimum path loss criterion.

S320: The first node determines a third node and a transmission configuration parameter based on the main path, where the third node is a node through which the transmission path between the first node and the second node necessarily passes.

In a possible implementation, the first node determines the third node and the transmission configuration parameter based on the main path and at least one of the following: a quantity of transport blocks, a threshold of a bit error rate, a total transmission delay, a duplex capability of a node on the main path, and a quantity of nodes.

Optionally, the transmission configuration parameter includes at least one of a node receiving/transmitting periodicity and a transmission delay between neighboring third nodes.

For example, the first node determines the third node on the main path and the transmission configuration parameter based on the main path and the quantity of transport blocks. If the source node needs to transmit a large quantity of transport blocks, the node receiving/transmitting periodicity may be appropriately shortened, that is, time for waiting for sending each transport block may be reduced. If the source node needs to transmit a small quantity of transport blocks, a quantity of third nodes on the main path or a quantity of hops between the source node and the destination node may be appropriately decreased.

For example, the first node determines the third node on the main path based on the main path and a reliability requirement (for example, a level of the reliability requirement may be learned through comparison between the threshold and the bit error rate). If the reliability requirement is relatively high (that is, the bit error rate is less than the threshold), a quantity of determined third nodes may be decreased, and a quantity of relay nodes between neighboring third nodes may alternatively be appropriately increased to improve transmission reliability (more paths are provided between the neighboring third nodes, so that transmission reliability can also be improved). It should be understood that the third node may also have a relay forwarding capability, and the relay node herein is a node between the neighboring third nodes that participates in transmission.

It should be understood that, the bit error rate may also be understood as a bit error rate or a block error (e.g. a code block) rate, and is a parameter representing transmission reliability. This is not limited in this disclosure.

For example, the first node determines the third node on the main path and the transmission configuration parameter based on the main path and the total transmission delay. The total transmission delay includes two parts. A first part is a delay of multi-hop transmission of a single transport block from the source node to the destination node, and a second part is time required for periodically sending the transport block. The first node determines the third node on the main path and the transmission configuration parameter based on the total transmission delay, so that a delay of the transport block from the source node to the destination node meets a total transmission delay requirement of the transport block.

For example, the first node determines the third node on the main path and the transmission configuration parameter based on the duplex capability of the node on the main path. If the third node is a half-duplex node, the transmission configuration parameter further includes a transmitting time unit and a receiving time unit. When the third node is a half-duplex node, the third node cannot simultaneously receive and send a transport block. Therefore, a transmitting time unit and a receiving time unit need to be further configured for the third node, to avoid a conflict between the transmitting time unit and the receiving time unit.

For example, the first node determines the third node on the main path and the transmission configuration parameter based on the main path and the quantity of nodes. If a quantity of nodes in a communication system is small, a quantity of third nodes may be appropriately increased, to decrease a quantity of relay nodes between neighboring third nodes, thereby reducing complexity of coordinated transmission.

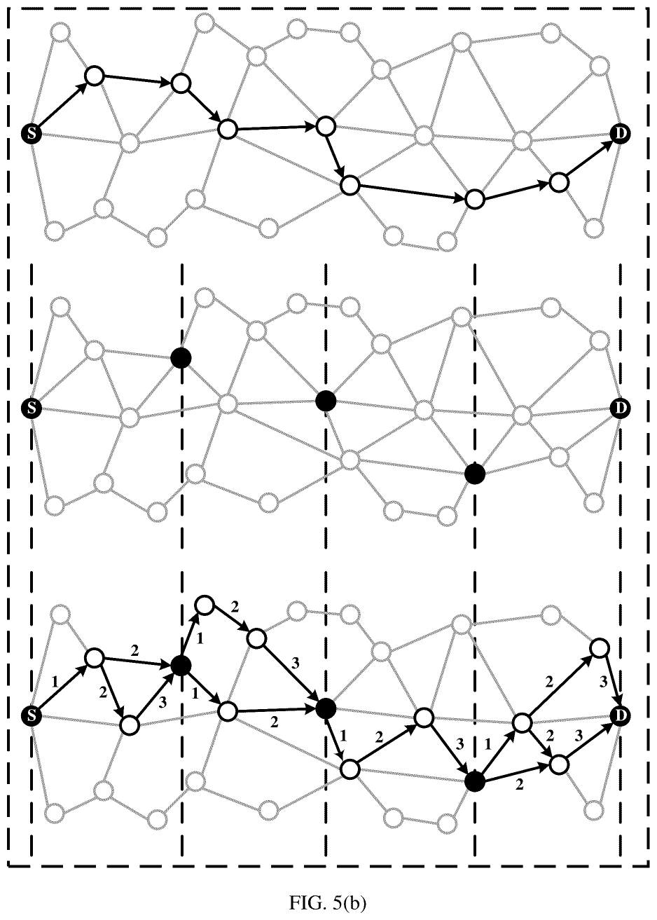

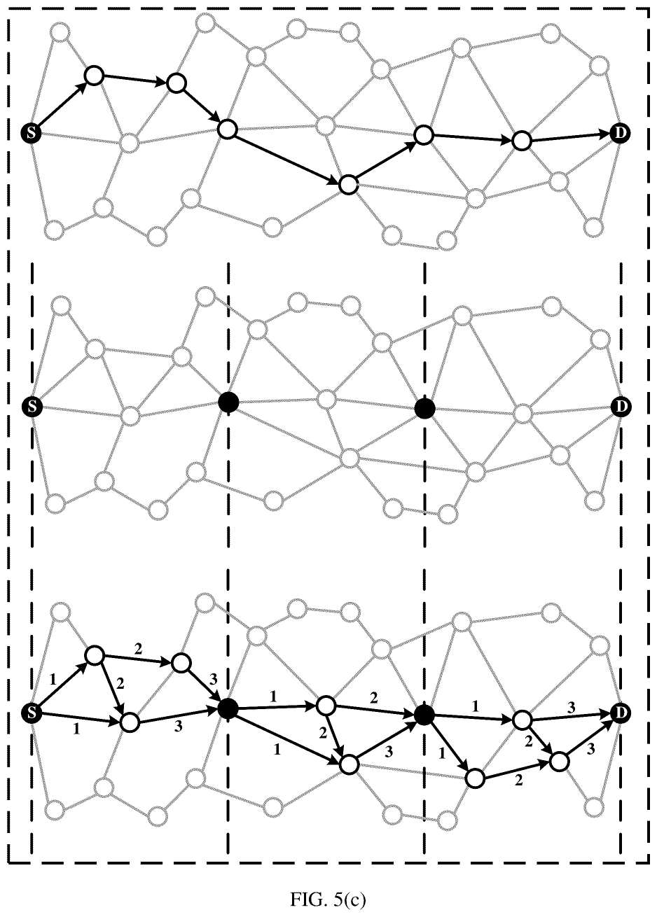

FIG. 5(a) to FIG. 5(c) are schematics of different quantities of third nodes in a same network topology according to an embodiment of this disclosure.

As shown in FIG. 5(a), five third nodes (other than a source node and a destination node) are selected on a main path. The source node (S) and the destination node (D) on the main path are also third nodes, a receiving/transmitting periodicity of the third node is 2, multi-hop transmission delays between neighboring third nodes are respectively 2/2/2/2/2/2, and quantities of relay nodes between the neighboring third nodes are respectively 1/1/0/2/1/2 (the third node may determine, based on a channel, which node is a relay node; and if the channel changes, the third node may further adjust a selected relay node based on the change of the channel). A number above a connection line shown in FIG. 5(a) may represent a time unit index. As shown in FIG. 5(a), a large quantity of third nodes are selected on the main path, and a quantity of relay nodes between neighboring third nodes is small. Therefore, this is relatively applicable to a scenario in which a quantity of transport blocks is large and complexity of coordinated transmission is low.

As shown in FIG. 5(b), three third nodes (other than a source node and a destination node) are selected on a main path. The source node (S) and the destination node (D) on the main path are also third nodes, a receiving/transmitting periodicity of the third node is 2, multi-hop transmission delays between neighboring third nodes are respectively 3/3/3/3, and quantities of relay nodes between the neighboring third nodes are respectively 2/3/2/3 (the third node may determine, based on a channel, which node is a relay node; and if the channel changes, the third node may further adjust a selected relay node based on the change of the channel). A number above a connection line shown in FIG. 5(b) may represent a time unit index. As shown in FIG. 5(b), a quantity of third nodes selected on the main path is moderate, and a quantity of relay nodes between neighboring third nodes is large. Therefore, this is relatively applicable to a scenario in which a quantity of transport blocks is large and a reliability requirement is high.

As shown in FIG. 5(c), two third nodes (other than a source node and a destination node) are selected on a main path. The source node (S) and the destination node (D) on the main path are also third nodes, a receiving/transmitting periodicity of the third node is 3, multi-hop transmission delays between neighboring third nodes are respectively 3/3/3, and quantities of relay nodes between the neighboring third nodes are respectively 3/2/3 (the third node may determine, based on a channel, which node is a relay node; and if the channel changes, the third node may further adjust a selected relay node based on the change of the channel). A number above a connection line shown in FIG. 5(c) may represent a time unit index. As shown in FIG. 5(c), a small quantity of third nodes are selected on the main path, and a quantity of relay nodes between neighboring third nodes is large. Therefore, this is relatively applicable to a scenario in which a quantity of transport blocks is small and a total transmission delay is low.

S330: The first node sends the transmission configuration parameter to the third node, where the transmission configuration parameter is used to determine a transmission manner between neighboring third nodes. Correspondingly, the third node receives the transmission configuration parameter.

S340: After receiving the transmission configuration parameter, the third node determines the transmission manner between the neighboring third nodes based on the transmission configuration parameter.

In a possible implementation, the third node determines information about the transmission manner between the neighboring third nodes based on the transmission configuration parameter, where the information about the transmission manner includes at least one of the following: a relay node between the neighboring third nodes, a quantity of relay nodes, and the transmission manner between the neighboring third nodes, and the relay node is a node between the neighboring third nodes that participates in transmission.

For example, the transmission manner includes a transmission path and a time unit corresponding to the transmission path, and the transmission path includes a direct transmission path (for example, a single-hop path, that is, only one hop is required between the neighboring third nodes) between the neighboring third nodes, and a relay transmission path (for example, a multi-hop path, that is, a plurality of hops are required between the neighboring third nodes, a relay node between the neighboring third nodes may vary, and a quantity of relay nodes may also vary, where the relay node is a node between the neighboring third nodes that participates in transmission) between the neighboring third nodes. It can be learned that, the transmission manner between the neighboring third nodes is flexible, may be selected based on a requirement, and does not need to be centrally configured by the first node.

When the third node is a full-duplex node, and the relay node between the neighboring third nodes is also a full-duplex node, a receiving/transmitting periodicity of a node (including the third node and the relay node) is less than or equal to a transmission delay between the neighboring third nodes, and there is no need to coordinate a receiving time unit and a transmitting time unit between the neighboring third nodes (the full-duplex node may simultaneously perform receiving and sending). The third node may determine the transmission manner between the neighboring third nodes based on four factors: the node receiving/transmitting periodicity, the transmission delay between the neighboring third nodes, the quantity of relay nodes between the neighboring third nodes, and the transmission path between the neighboring third nodes.

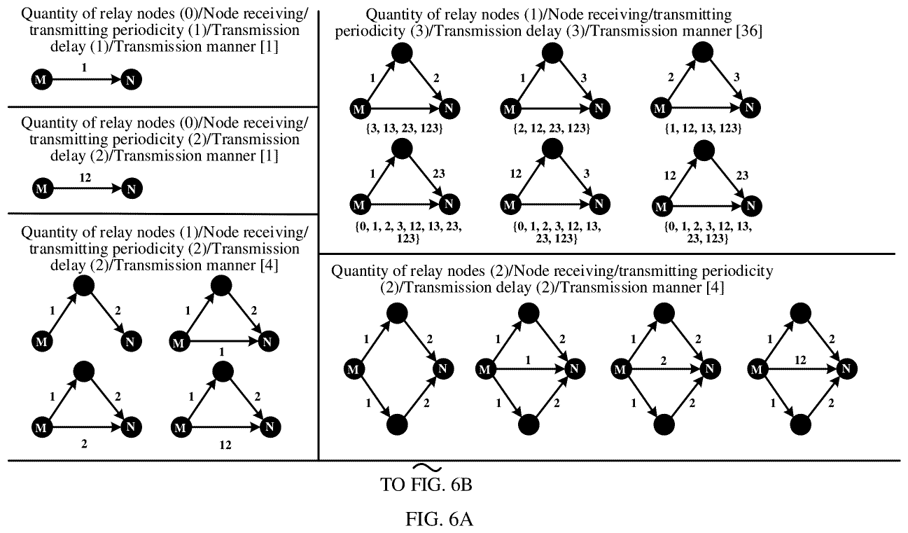

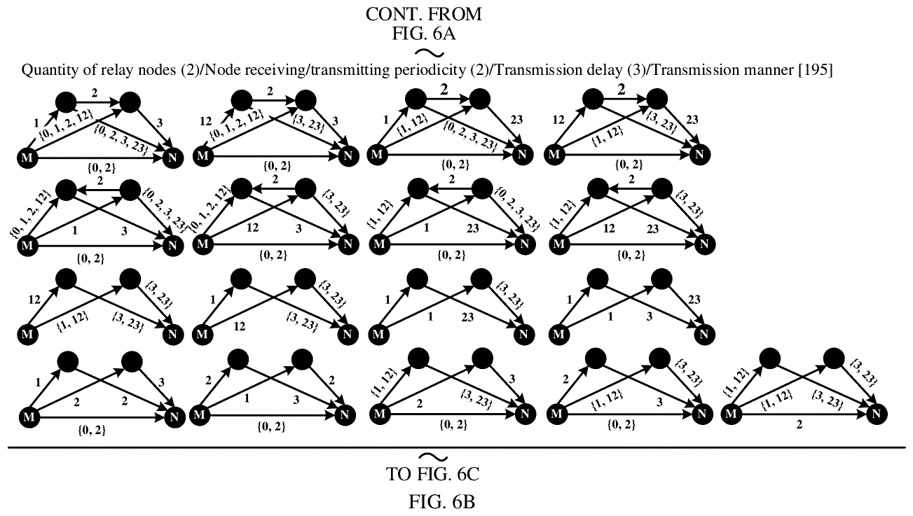

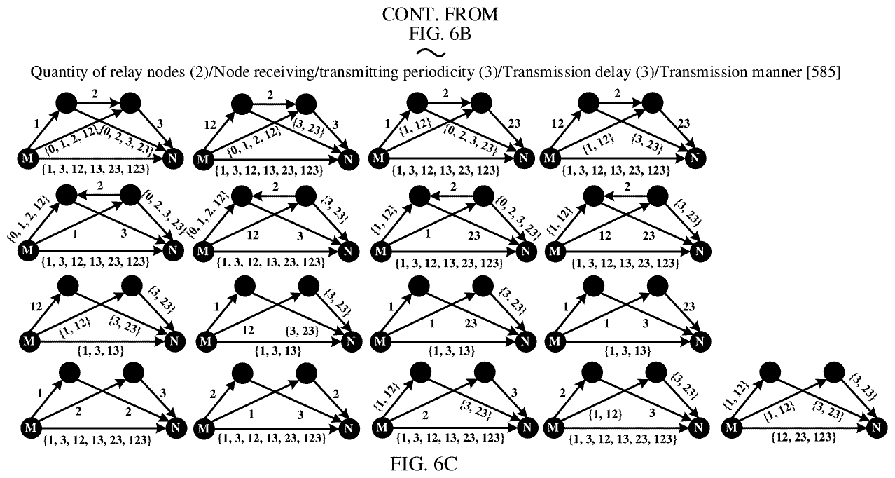

Table 3 shows all possible transmission manners between neighboring third nodes when no congestion, conflict, or collision occurs in a multi-hop network in cases of different node receiving/transmitting periodicities, different transmission delays between the neighboring third nodes, and different quantities of relay nodes. FIG. 6A to FIG. 6C illustrate all transmission manners between neighboring third nodes in different cases. M represents a third node #1, N represents a third node #2, and the third node #2 is a third node adjacent to the third node #1. A solid circle in the figure represents a full-duplex node, a solid circle other than the two third nodes M and N is a relay node, a connection line with an arrow represents a transmission path, a direction pointed by the arrow is a transmission direction, and a number represents a time unit index. If a time unit index is 0, it indicates that transmission is not performed in anytime unit. The same is understood for similar cases in the following.

TABLE 3

| Quantity of | Node receiving/ | Transmission | Transmission |
|---|---|---|---|
| relay nodes | transmitting periodicity | delay | manner |
| 0 | 1 | 1 | 1 |
| 0 | 2 | 2 | 1 |
| 1 | 2 | 2 | 4 |
| 1 | 3 | 3 | 36 |
| 2 | 2 | 2 | 4 |
| 2 | 2 | 3 | 195 |
| 2 | 3 | 3 | 585 |

For example, with reference to Table 3 and FIG. 6A to FIG. 6C, all possible transmission manners between the third node #1 and the third node #2 are described for a case in which the quantity of relay nodes is 1, the node receiving/transmitting periodicity is 2, and the transmission delay is 2. Other cases are deduced by analogy, and details are not described. There are four transmission manners between the third node #1 and the third node #2. In a first transmission manner, the third node #1 sends a transport block to the relay node by using a time unit #1 (a time unit whose index is 1, where the same is understood for similar descriptions in the following), and the relay node sends the transport block to the third node #2 by using a time unit #2. In a second transmission manner, the third node #1 simultaneously sends a transport block to the relay node and the third node #2 by using the time unit #1, and the relay node sends the transport block to the third node #2 by using the time unit #2. In a third transmission manner, the third node #1 sends a transport block to the relay node by using the time unit #1, and the third node #1 and the relay node simultaneously send the transport block to the third node #2 by using the time unit #2. In a fourth transmission manner, the third node #1 simultaneously sends a transport block to the relay node and the third node #2 by using the time unit #1, and the third node #1 and the relay node simultaneously send the transport block to the third node #2 by using the time unit #2.

It should be understood that transport blocks that simultaneously arrive at a same node in the third and fourth transmission manners are a same transport block. Therefore, no collision occurs. For example, in the third transmission manner, the third node #2 simultaneously receives, in the time unit #2, a same transport block sent from the third node #1 and the relay node. The third node #1 may select, based on a signal-to-noise ratio of a transmission path, which of the foregoing transmission manners is to be specifically used to transmit a transport block to the third node #2. Alternatively, the third node #1 may select, in another manner, a transmission manner used to transmit a transport block to the third node #2. This is not limited in this disclosure.

Table 4 shows signal-to-noise ratios required in five transmission manners (a node receiving/transmitting periodicity is 2, and a transmission delay is 2) when a block error rate is equal to 0.1 in cases of different path losses. It can be learned that, when a path loss from the third node #1 to the third node #2 is far greater than a path loss from the third node #1 to the relay node and a path loss from the relay node to the third node #2, the first transmission manner is selected. When the path loss from the third node #1 to the third node #2 is far greater than the path loss from the third node #1 to the relay node, and the path loss from the relay node to the third node #2 is between the two, the second transmission manner is selected. When the path loss from the third node #1 to the third node #2 is close to the path loss from the third node #1 to the relay node or from the relay node to the third node #2, direct transmission and retransmission between neighboring third nodes are selected. Direct transmission between the neighboring third nodes is transmission between the neighboring third nodes without relay assistance, and retransmission is repeated transmission of a same transport block between the neighboring third nodes.

TABLE 4

| | Direct | | | | |
|---|---|---|---|---|---|
| | transmission and | | | | |
| | retransmission | | | | |
| | between | First | Second | Third | Fourth |
| | neighboring third | transmission | transmission | transmission | transmission |
| Path loss | nodes | manner | manner | manner | manner |
| Third node #1 to | −9.7 dB | −15.8 dB | −12.5 dB | −11.8 dB | −8.5 dB |
| third node #2: 10 dB | | | | | |
| Third node #1 to | | | | | |
| relay node: 0 dB | | | | | |
| Relay node to third | | | | | |
| node #2: 0 dB | | | | | |
| Third node #1 to | −9.7 dB | −9.9 dB | −10.7 dB | −7.0 dB | −8.4 dB |
| third node #2: 10 dB | | | | | |
| Third node #1 to | | | | | |
| relay node: 0 dB | | | | | |
| Relay node to third | | | | | |
| node #2: 6 dB | | | | | |
| Third node #1 to | −9.7 dB | −6.0 dB | −7.7 dB | −4.5 dB | −8.3 dB |
| third node #2: 10 dB | | | | | |
| Third node #1 to | | | | | |
| relay node: 0 dB | | | | | |
| Relay node to third | | | | | |
| node #2: 10 dB | | | | | |
| Third node #1 to | −9.7 dB | −6.0 dB | −2.8 dB | −2.0 dB | −7.7 dB |
| third node #2: 10 dB | | | | | |
| Third node #1 to | | | | | |
| relay node: 10 dB | | | | | |
| Relay node to third | | | | | |
| node #2: 0 dB | | | | | |

It should be understood that, a unit of the node receiving/transmitting periodicity and a unit of the transmission delay may be a time unit, and the time unit may be a slot, a frame, or the like. This is not limited in this disclosure. The same is understood for similar cases in the following.

When the third node is a full-duplex node, and the relay node between the neighboring third nodes is a half-duplex node, a receiving/transmitting periodicity of a node (including the third node and the relay node) is less than or equal to a transmission delay between the neighboring third nodes, and there is no need to coordinate a receiving time unit and a transmitting time unit between the neighboring third nodes (the full-duplex node may simultaneously perform receiving and sending). The third node may determine the transmission manner between the neighboring third nodes based on four factors: the node receiving/transmitting periodicity, the transmission delay between the neighboring third nodes, the quantity of relay nodes between the neighboring third nodes, and the transmission path between the neighboring third nodes.

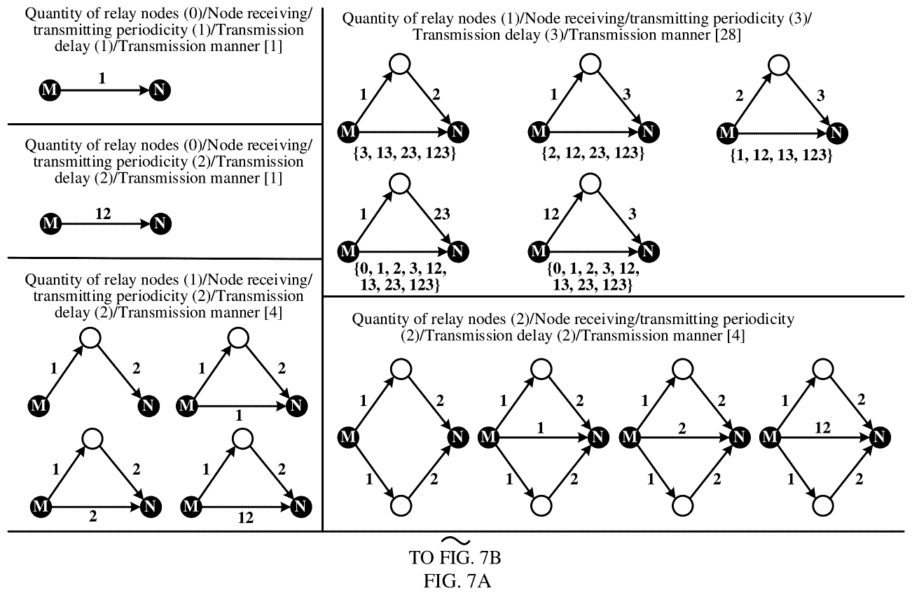

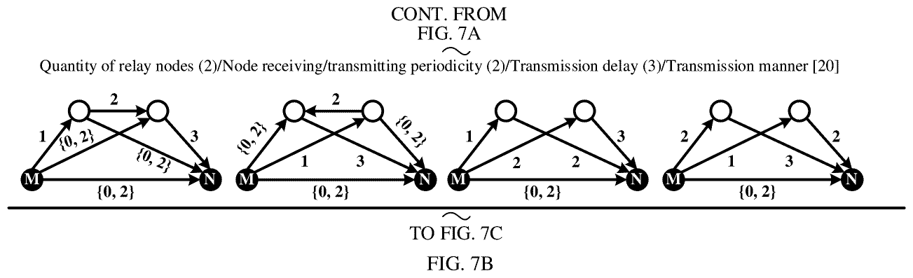

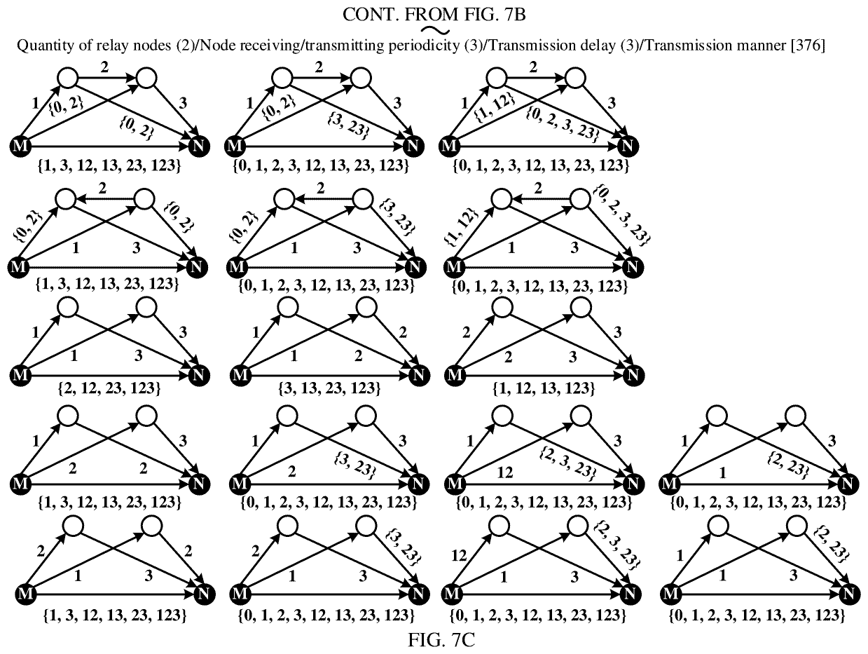

Table 5 shows all possible transmission manners between neighboring third nodes when no congestion, conflict, or collision occurs in a multi-hop network in cases of different node receiving/transmitting periodicities, different transmission delays between the neighboring third nodes, and different quantities of relay nodes. FIG. 7A to FIG. 7C illustrate all transmission manners between neighboring third nodes in different cases. M represents a third node #1, N represents a third node #2, and the third node #2 is a third node adjacent to the third node #1. In the figure, a solid circle represents a full-duplex node, a hollow circle represents a half-duplex node (that is, a relay node), a connection line with an arrow represents a transmission path, a direction pointed by the arrow is a transmission direction, and a number represents a time unit index.

TABLE 5

| Quantity of | Node receiving/ | Transmission | Transmission |
|---|---|---|---|
| relay nodes | transmitting periodicity | delay | manner |
| 0 | 1 | 1 | 1 |
| 0 | 2 | 2 | 1 |
| 1 | 2 | 2 | 4 |
| 1 | 3 | 3 | 28 |
| 2 | 2 | 2 | 4 |
| 2 | 2 | 3 | 20 |
| 2 | 3 | 3 | 376 |

It can be learned from Table 5 that, because the relay node is a half-duplex node and cannot simultaneously perform receiving and sending, compared with a case in which the relay node is a full-duplex node, a quantity of transmission manners is smaller. For example, when the quantity of relay nodes is 1, the node receiving/transmitting periodicity is 3, and the transmission delay is 3, if the relay node is a full-duplex node, there are 36 transmission manners between the third node #1 and the third node #2. However, if the relay node is a half-duplex node, there are only 28 transmission manners between the third node #1 and the third node #2. For specific transmission manners, refer to FIG. 7A to FIG. 7C. Understanding of FIG. 7A to FIG. 7C is similar to that of FIG. 6A to FIG. 6C, and details are not described again. The third node #1 may select, based on a signal-to-noise ratio of a transmission path, a specific transmission manner in the plurality of transmission manners that is specifically used to transmit a transport block to the third node #2. Alternatively, the third node #1 may select, in another manner, a transmission manner used to transport a transport block to the third node #2. This is not limited in this disclosure.

When the third node is a half-duplex node, and the relay node between the neighboring third nodes is a half-duplex node, a receiving/transmitting periodicity of a node (including the third node and the relay node) is less than a transmission delay between the neighboring third nodes, and a receiving time unit and a transmitting time unit need to be coordinated between the neighboring third nodes (the half-duplex node cannot simultaneously perform receiving and sending). The third node may determine the transmission manner between the neighboring third nodes based on five factors: the node receiving/transmitting periodicity, the transmission delay between the neighboring third nodes, a receiving time unit and a transmitting time unit of a node, the quantity of relay nodes between the neighboring third nodes, and the transmission path between the neighboring third nodes.

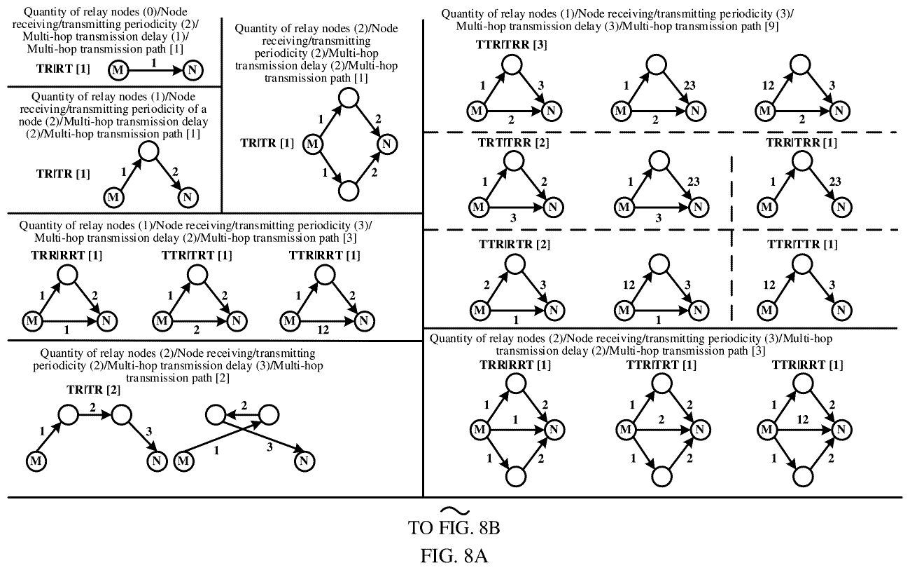

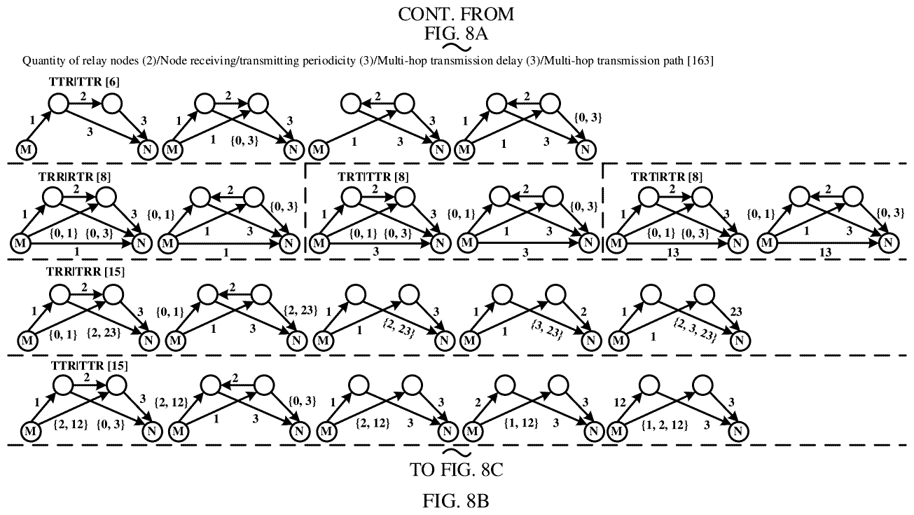

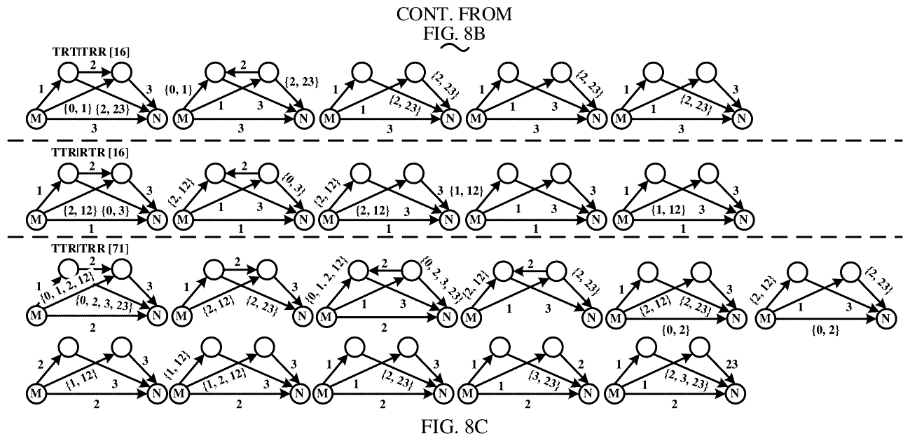

Table 6 shows all possible transmission manners between neighboring third nodes when no congestion, conflict, or collision occurs in a multi-hop network in cases of different node receiving/transmitting periodicities, different transmission delays between the neighboring third nodes, different transmitting time units and receiving time units, and different quantities of relay nodes. FIG. 8A to FIG. 8C illustrate all transmission manners between neighboring third nodes in different cases. M represents a third node #1, N represents a third node #2, and the third node #2 is a third node adjacent to the third node #1. A hollow circle in the figure represents a half-duplex node, a hollow circle node other than the two third nodes M and N is a relay node, a connection line with an arrow represents a transmission path, a direction pointed by the arrow is a transmission direction, and a number represents a time unit index.

TABLE 6

| Quantity | Node receiving/ | | Receiving/ | |
|---|---|---|---|---|
| of relay | transmitting | Transmission | transmitting | Transmission |
| nodes | periodicity | delay | time unit | manner |
| 0 | 2 | 2 | TR\|RT | 1 |
| 1 | 2 | 2 | TR\|TR | 1 |
| 1 | 3 | 2 | TRR\|RRT | 1 |
| | | | TTR\|TRT | 1 |
| | | | TTR\|RRT | 1 |
| 1 | 3 | 3 | TTR\|TRR | 3 |
| | | | TRT\|TRR | 2 |
| | | | TTR\|RTR | 2 |
| | | | TRR\|TRR | 1 |
| | | | TTR\|TTR | 1 |
| 2 | 2 | 2 | TR\|TR | 1 |
| 2 | 3 | 2 | TRR\|RRT | 1 |
| | | | TTR\|TRT | 1 |
| | | | TTR\|RRT | 1 |
| 2 | 2 | 3 | TR\|TR | 2 |
| 2 | 3 | 3 | TTR\|TRR | 71 |
| | | | TRT\|TRR | 16 |
| | | | TTR\|RTR | 16 |
| | | | TTR\|TTR | 15 |
| | | | TRR\|TRR | 15 |
| | | | TRR\|RTR | 8 |
| | | | TRT\|TTR | 8 |
| | | | TRT\|RTR | 8 |
| | | | TRR\|TTR | 6 |

In Table 6, the receiving/transmitting time unit is a receiving time unit and a transmitting time unit, T is the transmitting time unit, and R is the receiving time unit. For example, when the quantity of relay nodes is 1, the node receiving/transmitting periodicity is 3, and the transmission delay is 2, there are three transmission manners in total. In a first transmission manner, the third node #1 simultaneously sends a transport block to the relay node and the third node #2 by using a time unit #1, and the relay node sends the transport block to the third node #2 by using a time unit #2, where a receiving time unit and a transmitting time unit of each node are arranged as TRR or RRT. In a second transmission manner, the third node #1 sends a transport block to the relay node by using the time unit #1, and the relay node and the third node #1 simultaneously send a transport block to the third node #2 by using the time unit #2, where a receiving time unit and a transmitting time unit of each node are arranged as TTR or TRT. In a third transmission manner, the third node #1 simultaneously sends a transport block to the relay node and the third node #2 by using the time unit #1, and the relay node and the third node #1 simultaneously send a transport block to the third node #2 by using the time unit #2, where a receiving time unit and a transmitting time unit of each node are arranged as TTR or RRT. Cases in which the quantity of relay nodes, the node receiving/transmitting periodicity, and the transmission delay are other values are shown in FIG. 8A to FIG. 8C. Details are not described again. The third node #1 may select, based on a signal-to-noise ratio of a transmission path, which of the foregoing transmission manners is to be specifically used to transmit a transport block to the third node #2. Alternatively, the third node #1 may select, in another manner, a transmission manner used to transport a transport block to the third node #2. This is not limited in this disclosure.

A sequence of the steps in the foregoing flowchart is determined based on internal logic of the method. Sequence numbers shown in the foregoing flowchart are merely examples, and do not constitute a limitation on the sequence of the steps in this disclosure. The tables shown in embodiments of this disclosure are merely examples. The foregoing tables may alternatively be combined, split, or changed. This is not limited in this disclosure.

It should be further understood that the methods provided in embodiments of this disclosure may be used separately, or may be used in combination. This is not limited in this disclosure. Various implementations provided in embodiments of this disclosure may be used separately, or may be used in combination. This is not limited in this disclosure.

It should be understood that the term “and/or” in this disclosure describes only an association relationship between associated objects and represents that three relationships may exist. For example, “A and/or B” may represent the following three cases: Both A and B exist, only A exists, and only B exists, where A and B may be singular or plural. In addition, the character “/” in this specification usually indicates an “or” relationship between associated objects, but may also indicate an “and/or” relationship. For details, refer to the context for understanding.

In this disclosure, “at least one item (piece)” means one or more items (pieces), and “at least two items (pieces)” and “a plurality of items (pieces)” mean two or more items (pieces). “At least one of the following items (pieces)” or a similar expression thereof means any combination of these items, including a singular item (piece) or any combination of plural items (pieces). For example, at least one of a, b, or c may represent: a, b, c, a and b, a and c, b and c, or a, b, and c, where a, b, and c may be singular or plural.

It should be noted that, an execution body shown in FIG. 3 is merely an example, and the execution body may alternatively be a chip, a chip system, or a processor that supports the execution body in implementing the method shown in FIG. 3. This is not limited in this disclosure.

The foregoing describes the method embodiments in embodiments of this disclosure with reference to the accompanying drawings, and the following describes apparatus embodiments in embodiments of this disclosure. It may be understood that the descriptions of the method embodiments and the descriptions of the apparatus embodiments may correspond to each other. Therefore, for a part that is not described, refer to the foregoing method embodiments.

It may be understood that in the foregoing method embodiments, the method and the operation implemented by the first node may be implemented by a terminal device, a network device, or a component (for example, a chip or a circuit) in a terminal device or a network device, and the method and the operation implemented by the third node may be implemented by a terminal device, a network device, or a component (for example, a chip or a circuit) in a terminal device or a network device.

The foregoing mainly describes the solutions provided in embodiments of this disclosure from a perspective of interaction between network elements. It may be understood that, to implement the foregoing functions, each network element such as a transmitter device or a receiver device includes a corresponding hardware structure and/or software module for performing each function. A person skilled in the art should be able to be aware that, the units and the algorithm steps in the examples described with reference to embodiments disclosed in this specification can be implemented in this disclosure by hardware or a combination of hardware and computer software. Whether a function is performed by hardware or hardware driven by computer software depends on particular applications and design constraints of the technical solutions. A skilled person may use different methods to implement the described functions for each particular application, but this implementation should not be considered as beyond the scope of this disclosure.

In embodiments of this disclosure, functional modules of a transmitter device or a receiver device may be obtained through division based on the foregoing method examples. For example, each functional module may be obtained through division based on each function, or two or more functions may be integrated into one processing module. The integrated module may be implemented in a form of hardware, or may be implemented in a form of a software functional module. It should be noted that, in embodiments of this disclosure, division into the modules is an example, and is merely logical function division. In actual implementation, there may be another division manner. An example in which each functional module is obtained through division based on each corresponding function is used below for description.

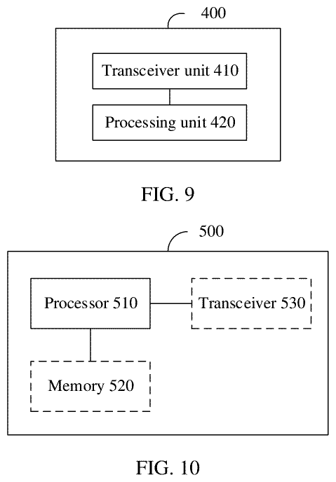

FIG. 9 is a schematic block diagram of a communication apparatus according to an embodiment of this disclosure. A communication apparatus 400 shown in FIG. 9 includes a transceiver unit 410 and a processing unit 420. The transceiver unit 410 may communicate with the outside, and the processing unit 420 is configured to perform data processing. The transceiver unit 410 may also be referred to as a communication interface or a communication unit.

Optionally, the transceiver unit 410 may include a sending unit and a receiving unit. The sending unit is configured to perform a sending operation in the foregoing method embodiments. The receiving unit is configured to perform a receiving operation in the foregoing method embodiments.

It should be noted that the communication apparatus 400 may include the sending unit, but does not include the receiving unit. Alternatively, the communication apparatus 400 may include the receiving unit, but does not include the sending unit. Specifically, this may depend on whether the foregoing solution performed by the communication apparatus 400 includes a sending action and a receiving action.

Optionally, the communication apparatus 400 may further include a storage unit. The storage unit may be configured to store instructions and/or data. The processing unit 420 may read the instructions and/or the data in the storage unit.

In a design, the communication apparatus 400 may be configured to perform actions performed by the first node in the foregoing method embodiment (the method 300).

Optionally, the communication apparatus 400 may be a terminal device or a network device. The transceiver unit 410 is configured to perform a receiving or sending operation of the first node in the foregoing method embodiments. The processing unit 420 is configured to perform an internal processing operation of the first node in the foregoing method embodiments.

Optionally, the communication apparatus 400 may be a device including a terminal device or a network device. Alternatively, the communication apparatus 400 may be a component configured in a terminal device or a network device, for example, a chip in the terminal device or the network device. In this case, the transceiver unit 410 may be an interface circuit, a pin, or the like. Specifically, the interface circuit may include an input circuit and an output circuit, and the processing unit 420 may include a processing circuit.

In a possible implementation, the processing unit 420 is configured to determine a main path, where the main path includes a transmission path that is between the first node and a second node and that meets a condition; the processing unit 420 is further configured to determine a third node and a transmission configuration parameter based on the main path, where the third node is a node through which the transmission path between the first node and the second node necessarily passes; and the transceiver unit 410 is configured to send the transmission configuration parameter to the third node, where the transmission configuration parameter is used to determine a transmission manner between neighboring third nodes.

In a possible implementation, the condition includes any one of the following: a hop count from the first node to the second node is minimum, or a path loss from the first node to the second node is minimum.

In a possible implementation, the processing unit 420 determines the third node and the transmission configuration parameter based on the main path and at least one of the following: a quantity of transport blocks, a threshold of a bit error rate, a total transmission delay, a duplex capability of a node on the main path, and a quantity of nodes.

In a possible implementation, the transmission configuration parameter includes at least one of a node receiving/transmitting periodicity and a transmission delay between neighboring third nodes.

In a possible implementation, the third node is a half-duplex node, and the transmission configuration parameter further includes a transmitting time unit and a receiving time unit.

In a possible implementation, the transceiver unit 410 is further configured to obtain configuration information of a neighboring node, where the configuration information includes a next-hop node and a destination node, or the configuration information further includes a hop count or a path loss; and the processing unit 420 is further configured to determine the main path based on the configuration information.

In another design, the communication apparatus 400 shown in FIG. 9 may be configured to perform actions performed by the third node in the foregoing method embodiment (the method 300).

Optionally, the communication apparatus 400 may be a terminal device or a network device. The transceiver unit 410 is configured to perform a receiving or sending operation of the third node in the foregoing method embodiments. The processing unit 420 is configured to perform an internal processing operation of the third node in the foregoing method embodiments.

Optionally, the communication apparatus 400 may be a device including a terminal device or a network device. Alternatively, the communication apparatus 400 may be a component configured in a terminal device or a network device, for example, a chip in the terminal device or the network device. In this case, the transceiver unit 410 may be an interface circuit, a pin, or the like. Specifically, the interface circuit may include an input circuit and an output circuit, and the processing unit 420 may include a processing circuit.

In a possible implementation, the transceiver unit 410 is configured to obtain a transmission configuration parameter, where the transmission configuration parameter is used to determine a transmission manner between neighboring third nodes, a main path includes a transmission path that is between a first node and a second node and that meets a condition, and the third node is a node through which the transmission path between the first node and the second node necessarily passes; and the processing unit 420 is configured to determine the transmission manner between the neighboring third nodes based on the transmission configuration parameter.

In a possible implementation, the condition includes at least one of the following: a hop count from the first node to the second node is minimum, or a path loss from the first node to the second node is minimum.

In a possible implementation, the transmission configuration parameter includes at least one of a node receiving/transmitting periodicity and a transmission delay between neighboring third nodes.

In a possible implementation, the third node is a half-duplex node, and the transmission configuration parameter further includes a transmitting time unit and a receiving time unit.

In a possible implementation, the processing unit 420 is further configured to determine information about the transmission manner between the neighboring third nodes based on the transmission configuration parameter, where the information about the transmission manner includes at least one of the following: a relay node between the neighboring third nodes, a quantity of relay nodes, and the transmission manner between the neighboring third nodes, and the relay node is a node between the neighboring third nodes that participates in transmission.

In a possible implementation, the transmission manner between the neighboring third nodes includes a transmission path and a time unit corresponding to the transmission path.

As shown in FIG. 10, an embodiment of this disclosure further provides a communication apparatus 500. The communication apparatus 500 includes a processor 510. The processor 510 is coupled to a memory 520. The memory 520 is configured to store a computer program or instructions and/or data. The processor 510 is configured to execute the computer program or the instructions and/or the data stored in the memory 520, so that the method in the foregoing method embodiment is performed.

Optionally, the communication apparatus 500 includes one or more processors 510.

Optionally, as shown in FIG. 10, the communication apparatus 500 may further include the memory 520.

Optionally, the communication apparatus 500 may include one or more memories 520.

Optionally, the memory 520 and the processor 510 may be integrated together or separately disposed.

Optionally, as shown in FIG. 10, the communication apparatus 500 may further include a transceiver 530 and/or a communication interface. The transceiver 530 and/or the communication interface are/is configured to receive and/or send a signal. For example, the processor 510 is configured to control the transceiver 530 and/or the communication interface to receive and/or send a signal.

Optionally, a component that is in the transceiver 530 and that is configured to implement a receiving function may be considered as a receiving module, and a component that is in the transceiver 530 and that is configured to implement a sending function may be considered as a sending module. In other words, the transceiver 530 includes a receiver and a transmitter. The transceiver may also be sometimes referred to as a transceiver machine, a transceiver module, a transceiver circuit, or the like. The receiver may also be sometimes referred to as a receiver machine, a receiving module, a receiving circuit, or the like. The transmitter may also be sometimes referred to as a transmitter machine, a transmitter, a sending module, a sending circuit, or the like.

In a solution, the communication apparatus 500 is configured to implement operations performed by the first node in the foregoing method 300. For example, the processor 510 is configured to implement an operation (for example, operations in S310 and S320) performed inside the first node in the foregoing method embodiments, and the transceiver 530 is configured to implement a receiving or sending operation (for example, an operation in S330) performed by the first node in the foregoing method embodiments.

In a solution, the communication apparatus 500 is configured to implement operations performed by the third node in the foregoing method embodiments. For example, the processor 510 is configured to implement an operation (for example, an operation in S340) performed inside the third node in the foregoing method 300, and the transceiver 530 is configured to implement a receiving or sending operation (for example, an operation in step S330) performed by the third node in the foregoing method embodiments.

An embodiment of this disclosure further provides a communication apparatus 600. The communication apparatus 600 may be a terminal device or may be a chip. The communication apparatus 600 may be configured to perform operations performed by the first node or the third node in the foregoing method embodiment (the method 300).

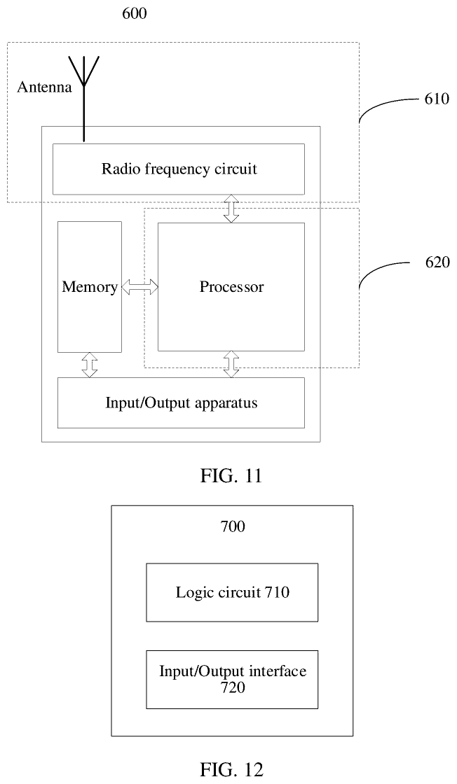

When the communication apparatus 600 is a terminal device, FIG. 11 is a simplified diagram of a structure of the terminal device. As shown in FIG. 11, the terminal device includes a processor, a memory, a radio frequency circuit, an antenna, and an input/output apparatus. The processor is mainly configured to: process a communication protocol and communication data, control the terminal device, execute a software program, process data of the software program, and so on. The memory is mainly configured to store the software program and data. The radio frequency circuit is mainly configured to: perform conversion between a baseband signal and a radio frequency signal, and process the radio frequency signal. The antenna is mainly configured to receive and send a radio frequency signal in a form of an electromagnetic wave. The input/output apparatus, such as a touchscreen, a display, or a keyboard, is mainly configured to: receive data input by a user and output data to the user. It should be noted that some types of terminal devices may have no input/output apparatus.

When data needs to be sent, after performing baseband processing on the to-be-sent data, the processor outputs a baseband signal to the radio frequency circuit; and the radio frequency circuit performs radio frequency processing on the baseband signal and then sends a radio frequency signal to the outside in a form of an electromagnetic wave through the antenna. When data is sent to the terminal device, the radio frequency circuit receives a radio frequency signal through the antenna, converts the radio frequency signal into a baseband signal, and outputs the baseband signal to the processor; and the processor converts the baseband signal into data, and processes the data. For ease of description, FIG. 11 shows only one memory and one processor. In an actual terminal device product, there may be one or more processors and one or more memories. The memory may also be referred to as a storage medium, a storage device, or the like. The memory may be disposed independent of the processor, or may be integrated with the processor. This is not limited in this embodiment of this disclosure.

In this embodiment of this disclosure, the antenna and the radio frequency circuit that have a receiving/transmitting function may be considered as a transceiver unit of the terminal device, and the processor that has a processing function may be considered as a processing unit of the terminal device.

As shown in FIG. 11, the terminal device includes a transceiver unit 610 and a processing unit 620. The transceiver unit 610 may also be referred to as a transceiver, a transceiver machine, a transceiver apparatus, a transceiver circuit, or the like. The processing unit 620 may also be referred to as a processor, a processing board, a processing module, a processing apparatus, or the like.

Optionally, a component that is in the transceiver unit 610 and that is configured to implement a receiving function may be considered as a receiving unit, and a component that is in the transceiver unit 610 and that is configured to implement a sending function may be considered as a sending unit. In other words, the transceiver unit 610 includes the receiving unit and the sending unit. The receiving unit may also be referred to as a receiver machine, a receiver, a receiving apparatus, a receiving circuit, or the like. The sending unit may also be referred to as a transmitter machine, a transmitter, a transmitting apparatus, a transmitting circuit, or the like.

In an implementation, the processing unit 620 and the transceiver unit 610 are configured to perform operations on a first node side in FIG. 3.

For example, the processing unit 620 is configured to perform processing operations in S310 and S320 in FIG. 3. The transceiver unit 610 is configured to perform a receiving/transmitting operation in S330 in FIG. 3.

In another implementation, the processing unit 620 and the transceiver unit 610 are configured to perform operations on a third node side in FIG. 3.

For example, the processing unit 620 is configured to perform a processing operation in S340 in FIG. 3. The transceiver unit 610 is configured to perform a receiving/transmitting operation in S330 in FIG. 3.

It should be understood that FIG. 11 is merely an example but not a limitation. The terminal device including the transceiver unit and the processing unit may not depend on the structure shown in FIG. 11.

When the communication apparatus 600 is a chip, the chip includes a transceiver unit and a processing unit. The transceiver unit may be an input/output circuit or a communication interface. The processing unit may be a processor, a microprocessor, or an integrated circuit integrated on the chip.

As shown in FIG. 12, an embodiment of this disclosure further provides a communication apparatus 700. The communication apparatus 700 includes a logic circuit 710 and an input/output interface 720.

The logic circuit 710 may be a processing circuit in the communication apparatus 700. The logic circuit 710 may be connected to a storage unit through coupling, and invoke instructions in the storage unit, so that the communication apparatus 700 can implement the methods and functions in embodiments of this disclosure. The input/output interface 720 may be an input/output circuit in the communication apparatus 700, and outputs information processed by the communication apparatus 700, or inputs to-be-processed data or signaling information to the communication apparatus 700 for processing.

In a solution, the communication apparatus 700 is configured to implement operations performed by the first node in the foregoing method embodiments.

For example, the logic circuit 710 is configured to implement a processing-related operation performed by the first node in the foregoing method embodiments, for example, is configured to implement a processing operation in step S310 or S320 in the method 300. The input/output interface 720 is configured to implement a sending-related operation and/or a receiving-related operation performed by the first node in the foregoing method embodiments, for example, a receiving/transmitting operation of the first node in step S330 in FIG. 3. For specific operations performed by the logic circuit 710, refer to the foregoing descriptions of the processing unit 420. For operations performed by the input/output interface 720, refer to the foregoing descriptions of the transceiver unit 410. Details are not described herein again.

In another solution, the communication apparatus 700 is configured to implement operations performed by the third node in the foregoing method embodiments.

For example, the logic circuit 710 is configured to implement a processing-related operation performed by the third node in the foregoing method embodiments, for example, a processing-related operation performed by the third node in the embodiment shown in FIG. 3. The input/output interface 720 is configured to implement a sending-related operation and/or a receiving-related operation performed by the third node in the foregoing method embodiments, for example, a receiving/transmitting operation performed by the third node in step S330 in FIG. 3. For specific operations performed by the logic circuit 710, refer to the foregoing descriptions of the processing unit 420, for example, a processing operation of the third node in step S340 in FIG. 3. For specific operations performed by the logic circuit 710, refer to the foregoing descriptions of the processing unit 420. For operations performed by the input/output interface 720, refer to the foregoing descriptions of the transceiver unit 410. Details are not described herein again.

It should be understood that the communication apparatus may be one or more chips. For example, the communication apparatus may be a field programmable gate array (FPGA), an application-specific integrated chip (ASIC), a system on chip (SoC), a central processing unit (CPU), a network processor (NP), a digital signal processor (DSP), a micro controller unit (MCU), a programmable logic device (PLD), or another integrated chip.

In an implementation process, the steps in the foregoing methods can be implemented by using a hardware integrated logical circuit in the processor, or by using instructions in a form of software. The steps in the methods disclosed with reference to embodiments of this disclosure may be directly performed and completed by a hardware processor, or may be performed and completed by using a combination of hardware in the processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with the hardware in the processor. To avoid repetition, details are not described herein again.

It should be noted that, the processor in embodiments of this disclosure may be an integrated circuit chip, and has a signal processing capability. In an implementation process, the steps in the foregoing method embodiments may be implemented by using a hardware integrated logic circuit in the processor or by using instructions in a form of software. The processor may be a general-purpose processor, a DSP, an ASIC, a FPGA or another programmable logic device, a discrete gate or a transistor logic device, or a discrete hardware component. The processor can implement or perform the methods, the steps, and the logical block diagrams that are disclosed in embodiments of this disclosure. The general-purpose processor may be a microprocessor, or the processor may be any conventional processor or the like. The steps in the methods disclosed with reference to embodiments of this disclosure may be directly performed and completed by a hardware decoding processor, or may be performed and completed by using a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with the hardware in the processor.

It may be understood that, the memory in embodiments of this disclosure may be a volatile memory or a nonvolatile memory, or may include a volatile memory and a nonvolatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. Through example but not limitative description, many forms of RAMs are available, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that the memories in the systems and methods described in this specification are intended to include but is not limited to these memories and any memory of another proper type.

According to the method provided in embodiments of this disclosure, this disclosure further provides a computer-readable medium, and the computer-readable medium stores program code. When the program code is run on a computer, the computer is enabled to perform the method in the embodiment shown in FIG. 3. For example, when the computer program is executed by a computer, the computer is enabled to implement the method performed by the first node or the method performed by the third node in the foregoing method embodiments.

An embodiment of this disclosure further provides a computer program product including instructions. When the instructions are executed by a computer, the computer is enabled to implement the method performed by the first node or the method performed by the third node in the foregoing method embodiments.

For explanations and beneficial effects of related content in any communication apparatus provided above, refer to the corresponding method embodiment described above. Details are not described herein again.

All or some of the foregoing embodiments may be implemented by using software, hardware, firmware, or any combination thereof. When software is used for implementation, all or some of embodiments may be implemented in a form of a computer program product. The computer program product includes one or more computer instructions. When the computer instructions are loaded and executed on a computer, all or some of the procedures or functions according to embodiments of this disclosure are generated. The computer may be a general-purpose computer, a dedicated computer, a computer network, or another programmable apparatus. The computer instructions may be stored in a computer-readable storage medium or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any available medium accessible by a computer, or a data storage device, such as a server or a data center, that includes one or more available media. The available medium may be a magnetic medium (for example, a floppy disk, a hard disk, or a magnetic tape), an optical medium (for example, a digital video disc (DVD)), a semiconductor medium (for example, a solid state disc (SSD)), or the like.

The first node and the third node in the foregoing apparatus embodiments correspond to the first node and the third node in the method embodiments, and corresponding modules or units perform corresponding steps, for example, the communication unit (e.g. a transceiver) performs a receiving or sending step in the method embodiments, and another step other than the sending and receiving steps may be performed by the processing unit (e.g. a processor). For a function of a specific unit, refer to the corresponding method embodiment. There may be one or more processors.

Terms such as “component”, “module”, and “system” used in this specification indicate computer-related entities, hardware, firmware, combinations of hardware and software, software, or software being executed. For example, a component may be but is not limited to a process that runs on a processor, a processor, an object, an executable file, an execution thread, a program, and/or a computer. As illustrated by using figures, both a computing device and an application that runs on the computing device may be components. One or more components may reside in a process and/or an execution thread, and a component may be located on one computer and/or distributed between two or more computers. In addition, these components may be executed from various computer-readable media that store various data structures. For example, the components may perform communication by using a local process and/or a remote process and based on a signal having one or more data packets (for example, data from two components interacting with another component in a local system, a distributed system, and/or across a network such as the Internet interacting with another system by using the signal).

A person of ordinary skill in the art may be aware that, the units and the algorithm steps in the examples described with reference to embodiments disclosed in this specification can be implemented by electronic hardware or a combination of computer software and electronic hardware. Whether the functions are performed by hardware or software depends on particular applications and design constraints of the technical solutions. A skilled person may use different methods to implement the described functions for each particular application, but this implementation should not be considered as beyond the scope of this disclosure.

It may be clearly understood by a person skilled in the art that, for convenient and brief description, for specific working processes of the system, apparatus, and unit described above, refer to corresponding processes in the foregoing method embodiments. Details are not described herein again.

In the several embodiments provided in this disclosure, it should be understood that the disclosed system, apparatus, and method may be implemented in other manners. For example, the apparatus embodiments described above are merely examples. For example, division into the units is merely logical function division, and there may be another division manner in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in an electrical form, a mechanical form, or another form.

The units described as separate parts may or may not be physically separate, and parts displayed as units may or may not be physical units, that is, may be located in one place, or may be distributed on a plurality of network units. Some or all of the units may be selected based on actual requirements to achieve the objectives of the solutions of embodiments.

In addition, functional units in embodiments of this disclosure may be integrated into one processing unit, each of the units may exist alone physically, or two or more units may be integrated into one unit.

When the function is implemented in a form of a software functional unit and sold or used as an independent product, the function may be stored in a computer-readable storage medium. Based on such an understanding, the technical solutions in this disclosure essentially, or the part contributing to the conventional technology, or some of the technical solutions may be implemented in a form of a software product. The computer software product is stored in a storage medium and includes several instructions for instructing a computer device (which may be a personal computer, a server, a network device, or the like) to perform all or some of the steps in the methods in embodiments of this disclosure. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. A method, comprising:
determining a main path, wherein the main path comprises a transmission path between a first node and a second node, and the main path meets a preset condition;
determining a third node from one or more third nodes and a transmission configuration parameter based on the main path, wherein each of the one or more third nodes is a node through which at least one transmission path between the first node and the second node necessarily passes; and
sending the transmission configuration parameter to the third node, wherein the transmission configuration parameter is associated with a transmission manner between neighboring third nodes of the one or more third nodes.

2. The method according to claim 1, wherein the preset condition comprises one or more of:
a hop count from the first node to the second node is a minimum hop count; or
a path loss from the first node to the second node is a minimum path loss.

3. The method according to claim 1, wherein determining the third node and the transmission configuration parameter based on the main path comprises:
determining the third node and the transmission configuration parameter based on the main path and one or more of:
a quantity of transport blocks, a threshold of a bit error rate, a total transmission delay, a duplex capability of a node on the main path, or a quantity of nodes.

4. The method according to claim 1, wherein the transmission configuration parameter comprises one or more of a node receiving/transmitting periodicity or a transmission delay between the neighboring third nodes.

5. The method according to claim 4, wherein the third node is a half-duplex node, and the transmission configuration parameter further comprises a transmitting time unit and a receiving time unit.

6. The method according to claim 1, wherein determining the main path comprises:
obtaining configuration information of a neighboring node, wherein the configuration information comprises a next-hop node and a destination node, and the configuration information further comprises a hop count or a path loss; and
determining the main path based on the configuration information.

7. A method, comprising:
obtaining a transmission configuration parameter, wherein the transmission configuration parameter is associated with a transmission manner between neighboring third nodes, at least one of the neighboring third nodes is on a transmission path between a first node and a second node that meets a preset condition, and each of the at least one of the neighboring third nodes is a node through which at least one transmission path between the first node and the second node necessarily passes; and
determining the transmission manner between the neighboring third nodes based on the transmission configuration parameter.

8. The method according to claim 7, wherein the preset condition comprises one or more of:
a hop count from the first node to the second node is a minimum hop count; or
a path loss from the first node to the second node is a minimum path loss.

9. The method according to claim 7, wherein the transmission configuration parameter comprises one or more of: a node receiving/transmitting periodicity or a transmission delay between the neighboring third nodes.

10. The method according to claim 9, wherein at least one of the third nodes is a half-duplex node, and the transmission configuration parameter further comprises a transmitting time unit and a receiving time unit.

11. The method according to claim 7, wherein determining the transmission manner between the neighboring third nodes based on the transmission configuration parameter comprises:
determining information about the transmission manner between the neighboring third nodes based on the transmission configuration parameter, wherein the information about the transmission manner comprises one or more of:
a relay node between the neighboring third nodes, a quantity of relay nodes, or the transmission manner between the neighboring third nodes, wherein each relay node is a node between the neighboring third nodes that participates in transmission.

12. The method according to claim 7, wherein the transmission manner between the neighboring third nodes comprises a transmission path between the neighboring third nodes and a time unit corresponding to the transmission path between the neighboring third nodes.

13. An apparatus, comprising:
a logic circuit; and
an input/output interface coupled with the logic circuit, wherein the logic circuit is configured to:
determine a main path, wherein the main path comprises a transmission path between a first node and a second node and the main path meets a preset condition;
determine an intermediate node of at least one intermediate node and a transmission configuration parameter based on the main path, wherein each of the at least one intermediate node is a node through which at least transmission path between the first node and the second node necessarily passes; and
wherein the input/output interface is configured to send the transmission configuration parameter to the intermediate node, wherein the transmission configuration parameter is associated with a transmission manner between neighboring intermediate nodes of the at least one intermediate node.

14. The apparatus according to claim 13, wherein the preset condition comprises one or more of:
a hop count from the first node to the second node is a minimum hop count; or
a path loss from the first node to the second node is a minimum path loss.

15. The apparatus according to claim 13, wherein the logic circuit is further configured to determine the intermediate node and the transmission configuration parameter based on the main path and one or more of:
a quantity of transport blocks, a threshold of a bit error rate, a total transmission delay, a duplex capability of a node on the main path, or a quantity of nodes.

16. The apparatus according to claim 13, wherein the transmission configuration parameter comprises one or more of: a node receiving/transmitting periodicity or a transmission delay between the neighboring intermediate nodes.

17. The apparatus according to claim 16, wherein the intermediate node is a half-duplex node, and the transmission configuration parameter further comprises a transmitting time unit and a receiving time unit.

18. The apparatus according to claim 13, wherein:
the input/output interface is further configured to obtain configuration information of a neighboring node, wherein the configuration information comprises a next-hop node and a destination node, and the configuration information further comprises a hop count or a path loss; and
the logic circuit is further configured to determine the main path based on the configuration information.
